(19) United States
(12) Patent Application Publication
(10) Pub. No.: US 2024/0330008 A1
(43) Pub. Date: Oct. 3, 2024

(54) METHOD AND APPARATUS FOR SYSTEM COMPONENT CONFIGURATION AND DIAGNOSTIC SCANNING

(71) Applicant: LightGuide, Inc., Wixom, MI (US)

(72) Inventors: William T. Sommerville, Wixom, MI (US); Douglas J. Mulka, Madison Heights, MI (US)

(21) Appl. No.: 18/625,642

(22) Filed: Apr. 3, 2024

Related U.S. Application Data
(60) Provisional application No. 63/493,857, filed on Apr. 3, 2023.
(60) Provisional application No. 63/493,861, filed on Apr. 3, 2023.

(51) Int. Cl. G06F 9/4401

(52) U.S. Cl. CPC G06F 9/4411

(57) ABSTRACT

Embodiments of the present invention provide methods and an apparatus to ensure the proper configuration of system components through the use of a configuration tool for automatically performing configuration steps and/or guiding a user through manual configuration steps. A configuration apparatus includes a configuration tool coupled to a system comprising a plurality of components configured to perform the system functionality. The configuration tool is communicatively coupled to the plurality of components via a network. The configuration tool is configured to perform a configuration process for a selected component of the plurality of components.

### CROSS REFERENCE TO RELATED APPLICATION

The present application claims priority of U.S. provisional application Ser. No. 63/493,857, filed Apr. 3, 2023, and Ser. No. 63/493,861, filed Apr. 3, 2023, which are hereby incorporated herein by reference in their entireties.

### FIELD OF THE INVENTION

The present invention is directed to improvements in setting up computer systems that include displays and peripherals, and in particular to setting up and performing diagnostic scans of a system that includes projectors and monitors.

### BACKGROUND OF THE INVENTION

Conventional manufacturing facilities include workers performing operational steps such as in the assembly, inspection, kitting, and/or training involved in manual processes. Numerous activities involve the performance of pre-designated operational steps to properly complete a particular task, with some such activities needing to be completed within a specified time or standard time allowance. The performance of such activities can be guided through the use of light guided systems that provide visual prompts and indicators to guide a worker in the performance of their work. Such visual prompts and indicators may provide instructions to workers as well as allow the workers to input responses. Such light guided systems are often complex interconnected systems. For these—and other similar—systems to function properly, their interconnected components need to be functioning properly and be properly configured. Such functionality and configurations can be difficult for some installations depending on the complexity of the system components. Such functionality and configurations can also be difficult to assess. While the information with respect to functionality and configuration data/state may be available, the information may be difficult to find or understand. The custom nature of the systems and the unique IT requirements of different manufacturing facilities further complicate the assignments.

### SUMMARY OF THE INVENTION

Embodiments of the present invention provide methods and an apparatus to ensure the proper setup and configuration of system components by completing the steps to a process for configuring the system components. In one embodiment, a system includes a configuration tool configured to guide the setup and configuration of the system's associated hardware/software and of at least one monitor, and/or projector, and/or spotlight. The configuration tool may be coupled to a plurality of components configured to perform the system's functionality. The configuration tool is communicatively coupled to the plurality of components. The configuration tool is configured to perform a configuration process for a selected component of the plurality of components. The method and apparatus of the present invention also provide for the proper functionality and configuration of computer system components by performing diagnostic scans of the computer system components. In one embodiment, a diagnostic tool is communicatively coupled to a system comprising a plurality of components. The diagnostic tool is configured to scan each of the components and determine whether resultant scan data has changed from a previous scan's scan data.

The configuration tool's resultant configuration details can be saved and used as a troubleshooting resource (e.g., used along with or by the diagnostic tool). In one embodiment, the diagnostic tool accesses or generates resolution tips such that a user can attempt to resolve one or more changes identified by the diagnostic tool. Such resolution tips can include one or more suggestions or directions for resolving the conflict with a previous diagnostic scan. As the configuration/setup tool is guiding a user through a system setup, the setup tool can capture or record configuration data that captures the configuration data as configuration steps are automatically and/or manually performed (with such configuration data comprising the who, what, where, when, and how of the configuration). This configuration data can be used to provide better diagnostic guidance for its diagnostic tool and its review of the diagnostic scan data and the generation and/or selection of resolution tips. The diagnostic tool uses the configuration data from the setup tool and its own diagnostic scan data to provide better diagnostics guidance. The diagnostic tool has access to what went into the system setup and can use that setup information to help guide diagnostics and the generation of relevant and helpful resolution tips for the user.

A configuration apparatus for a system includes a network, a plurality of components, and a configuration tool. The plurality of components are communicatively coupled to the network. The plurality of components are configured to perform the system's functionality. The configuration tool is communicatively coupled to the network and is configured to communicate with each of the plurality of components. The configuration tool is configured to perform a configuration process for a selected component of the plurality of components.

A diagnostic scanner for a computer system includes a diagnostic tool, a network, and one or more components. The diagnostic tool and the components are communicatively coupled to a network. The diagnostic tool scans each of the components and compares scan results to a previous scan. The diagnostic tool takes each of the detected changes from the previous scan and ranks them in accordance with their severity and oddity with respect to the system's ability to operate as expected.

A method for performing a configuration on a system that includes a plurality of components configured to monitor and guide manufacturing activities. The method includes initiating a configuration by selecting a first configuration to perform on a selected component of the plurality of components. A configuration file is retrieved from a database or a file. The retrieved configuration file corresponds to the first configuration for the selected component. The method also includes performing one or more configuration steps from the configuration file to configure the selected component. Corresponding configuration data is recorded to a log for each configuration step performed.

In an aspect of the present invention, the configuration tool is configured to access a database for a list of components and related configuration files. Each configuration file corresponds to a configuration procedure and other useful data for a respective component of the plurality of components. The configuration tool selects a configuration file that corresponds to the selected component for configuration. The database is stored on either a local memory or an external memory.

In another aspect of the present invention, the configuration tool performs each automated configuration step and provides instructions for the completion of each manual configuration step and determines whether each of the configuration steps has been completed and verified. The configuration tool records corresponding completion data and verification data for each configuration step.

In yet another aspect of the present invention, each configuration file includes at least one configuration step for configuring the corresponding component.

In another aspect of the present invention, the configuration tool includes at least one of a system setup tool and a display setup tool. The system setup tool performs and/or guides a user through a system component hardware/software configuration. The display setup tool performs and/or guides the user through a display configuration.

In a further aspect of the present invention, the display is a monitor, projector, fixed spotlight, motorized spotlight, tablet, wearable device, or a phone.

In another aspect of the present invention, the configuration tool outputs configuration data to a log.

In an aspect of the present invention, the configuration apparatus also includes a diagnostic tool for troubleshooting and correcting configuration errors in system components. The diagnostic tool receives the log from the configuration tool or from a memory location.

In another aspect of the present invention, system is a light guide system configured to monitor and guide manufacturing activities. The components comprise at least one of: a plurality of cameras, a plurality of projectors, a plurality of monitors, a system controller, one or more external computer systems, input/output devices, and a manufacturing execution system. The components are communicatively coupled via an Ethernet network or connected via USB, video cables, serial cables, or other media.

In a further aspect of the present invention, the cameras monitor the activities of workers at workstations in a manufacturing area. The projectors and monitors display information to the workers and guide manufacturing activities at the workstations.

An exemplary method for performing a diagnostic scan on a computer system that includes a plurality of components configured to monitor and guide manufacturing activities includes the initiation of a diagnostic scan by selecting a particular scan for a desired diagnostic report. A current line item is scanned by performing an associated test on a corresponding component of the plurality of components. Resulting test data from the associated test for the current line item is compared to reference data from a reference diagnostic scan. The comparison includes determining whether there is a change in the test data with respect to the reference data. Each change in the test data from the reference data is ranked according to severity and oddity (the ranking is also used to provide a ranked order of those identified line items with diagnostic data changes). The severity and oddity values are generally predetermined for each type of comparison and are based on the expert experience of others who have manually troubleshot many similar systems in the past. The severity and oddity are ranked with respect to the effect of the change in test data on system operability and the order in which it is recommended to make efforts to get the system operational again. The test data changes along with associated descriptions and recommended resolutions are recorded into memory for the current line item. The method includes checking whether there are any further line items still to be tested and incrementing to a next line item when there are further line items for testing and scanning the next line item. The test data is saved from the diagnostic scan as a diagnostic scan report when there are no further line items for testing.

According to an aspect of the present invention, a scan comprises a list of tests to be performed on the computer components. One or more tests are performed on each of the components. The diagnostic tool is configured to scan each of the components to determine for each at least one of: a configuration, a software version, an operational state or condition of the component, and information related to software drivers utilized by the component.

According to another aspect of the present invention, the components are components of a light guide system configured to monitor and guide manufacturing activities. The components include at least one of: a plurality of cameras, a plurality of projectors, a plurality of monitors, a system controller, one or more external computer systems, input/output devices, and a manufacturing execution system. The plurality of cameras are configured to monitor the activities of a worker at a work station in a manufacturing area. The plurality of projectors and monitors are configured to display information to the worker to guide manufacturing activities in the work station. The components may include network-connected components.

In another aspect of the present invention, the plurality of cameras are arranged around the work area.

In a further aspect of the present invention, the system controller includes a programmable logic controller.

In yet another aspect of the present invention, a diagnostic scanner is incorporated into at least one of the external computer systems, an operational software system, and a system controller.

In another aspect of the present invention, the list of tests to be performed are arranged as line items in a database that is accessed by the diagnostic tool.

These and other objects, advantages, purposes and features of the present invention will become apparent upon review of the following specification in conjunction with the drawings.

### BRIEF DESCRIPTION OF THE DRAWINGS

FIG. 1A is a block diagram of a system that includes a plurality of components of a light guide system configured for monitoring and evaluating operational activities at a workstation of a manufacturing area in accordance with the present invention;

FIG. 1B is a block diagram of an exemplary arrangement of projectors and monitors of the system of FIG. 1A and illustrating an alignment of the projectors with respect to the manufacturing area in accordance with the present invention;

FIGS. 1C, 1D, 1E, 1F, and 1G are of an exemplary display setup panel illustrating projector alignment for a display configuration in accordance with the present invention;

FIG. 2 illustrates the steps to a method for the configuration of a monitor or projector of the system of FIG. 1A in accordance with the present invention;

FIG. 3 is an exemplary control/configuration panel for accessing a system setup, a display setup, a diagnostic tool, and associated system information in accordance with the present invention;

FIG. 3A is an exemplary system information panel for displaying associated system information in accordance with the present invention;

FIGS. 3B and 3C are of another exemplary control/configuration panel for accessing a system setup, a display setup, a diagnostic tool, a “pack and go” backup setup, and associated system information in accordance with the present invention;

FIGS. 3D and 3E illustrate an exemplary system setup section of the control/configuration panel of FIG. 3A;

FIG. 3F is another view of the system setup panel of FIG. 3B illustrating a configuration status popup notification in accordance with the present invention;

FIG. 3G is an exemplary log report illustrating a report of configuration data for the configuration steps being performed in accordance with the present invention;

FIGS. 3H and 3I illustrate an exemplary system setup section of the control/configuration panel of FIG. 3A;

FIGS. 4A, 4B, 4C, and 4D are of an exemplary display setup panel illustrating procedural steps for selecting, setting up, and configuring a display in accordance with the present invention;

FIGS. 5A, 5B, 5C, 5D, and 5E are of the display setup panel of FIG. 4A and illustrating procedural steps for mounting the display in accordance with the present invention;

FIGS. 6A, 6B, 6C, 6D, 6E, 6F, and 6G are of the display setup panel of FIG. 4A and illustrating procedural steps for coupling power and data cables to the display in accordance with the present invention;

FIGS. 7A, 7B, and 7C are of the display setup panel of FIG. 4A and illustrating procedural steps for verifying the zoom, focus, and internal shift of the display in accordance with the present invention;

FIGS. 8A, 8B, 8C, and 8D are of the display setup panel of FIG. 4A and illustrating procedural steps for locking a graphics card to the display and verifying the configuration in accordance with the present invention;

FIGS. 8E, 8F, 8G, and 8H are of the display setup panel of FIG. 4A and illustrating procedural steps for configuring a display layout for the display and assigning a name to the display in accordance with the present invention;

FIGS. 9A, 9B, 9C, 9D, 9E, and 9F are of the display setup panel of FIG. 4A and illustrating procedural steps for configuring the menus of the display in accordance with the present invention;

FIG. 10 is of the display setup panel of FIG. 4A and illustrates the procedural step for configuring the display for automatic control in accordance with the present invention;

FIGS. 11A, 11B, 11C, and 11D are of the display setup panel of FIG. 4A and illustrating procedural steps for confirming and verifying the display's resolution in accordance with the present invention; and

FIGS. 12A, 12B, and 12C are of the display setup panel of FIG. 4A and illustrate configuration reports for the setup of the display in accordance with the present invention;

FIG. 13 illustrates an exemplary message board of the display setup panel showing skipped/missing configuration items in accordance with the present invention;

FIG. 14 illustrates the steps to a method for diagnostically scanning the components of the system of FIG. 1A in accordance with the present invention;

FIG. 15 is an exemplary display panel of the diagnostic scanner illustrating the severity and oddity ranking of the scan results for a particular component of the components of the system of FIG. 1A in accordance with the present invention;

FIG. 16 is an exemplary display panel of the diagnostic scanner illustrating the logic for assessing and ranking the scan results of FIG. 15;

FIGS. 17A, 17B, 17C, and 17D are exemplary display panels of the diagnostic scanner illustrating the scan results with associated severity and oddity rankings for the diagnostic scan of the components of the light guide system of FIG. 1A;

FIG. 17E illustrates exemplary interactive hardware status dashboard results that show current hardware topology, state, and other useful information from the diagnostic scan results, with user selectable additional information in accordance with the present invention;

FIGS. 17F and 17G illustrate an exemplary “pack and go” feature of the system providing for the selection other scan results, e.g., scans other than startup scans in accordance with the present invention; and

FIGS. 18A, 18B, 18C, and 18D are exemplary display panels of the diagnostic scanner illustrating other views of the scan results for the diagnostic scan of the components of the light guide system of FIG. 1A.

### DESCRIPTION OF THE PREFERRED EMBODIMENTS

The present invention will now be described with reference to the accompanying figures, wherein numbered elements in the following written description correspond to like-numbered elements in the figures. Methods and systems of the exemplary embodiments provide for a proper setup and configuration of system components. The system includes a configuration or setup tool configured to perform a set of steps to configure a selected component. In one embodiment, the selected component is a monitor and/or a projector. Thus, a system, such as an exemplary light guide system, may include a configuration tool for performing or guiding a user through a configuration process to set up a selected component of the light guide system. When the configuration tool detects errors in the configuration process, a report may be delivered to a diagnostic tool for troubleshooting and error correction. The configuration tool thus provides automated and/or guided configuration procedures for selected components of the light guide system.

In one embodiment, because a system's final configuration can have complications or complex procedures to be performed, exemplary embodiments provide for the ability to record and evaluate those configuration steps as they are carried out (completed). Such recording can include, for example, recording what steps are performed, what steps are yet to be performed, what steps are partially completed, who performed the configuration step(s), and recording the order in which the configuration steps are performed/completed). Such information can then be utilized during any subsequent diagnostic scanning or troubleshooting steps. The configuration system can include or record particular calibration programs (and related logs), alignment tools, and backup/store software to be used during any subsequent diagnostic scanning or troubleshooting.

Thus, the same algorithms used to help configure the system can also be used to ensure that the system continues to be in proper condition. For example, when the system software is updating, associated configuration settings might also change. Those configuration changes can be reviewed to ensure that the updated system has been properly configured (and that the updated configuration settings are appropriate). As necessary, the configuration backups can also be used to revert such configuration changes. Having a record of the individual who performed a previous configuration can also be used to aid in any subsequent diagnostic procedures (e.g., directing detailed questions to the individual responsible for the original configuration as well as reviewing what the original configuration intent or goals was). The configuration/setup tool 101 can also link resultant documentation (offline and online) so that others can be made aware of the relevant configuration details (e.g., to be used as troubleshooting resources).

As discussed herein, an exemplary diagnostic tool or scanner can be configured to access and/or generate a list of resolution tips to be displayed to a user, such that the user can try to resolve any changes identified by the diagnostic scanner/tool. Such resolution tips can include one or more suggestions or directions for resolving the conflict with a previous diagnostic scan. Such tips can include, for example, suggesting the user confirm that any affected displays (or similar technology) are displaying content as expected. If the displays are not functioning as expected, the user would be provided with a follow-up step, such as a direction to run a relevant display configuration wizard (again).

In one embodiment, a configuration or system setup tool guides the user through a system setup (comprising the setup/configuration steps for one or more system components). The configuration/setup tool can record configuration data that captures the configuration steps as they are automatically and/or manually performed (such configuration data will comprise the “who,” “what,” “where,” “when,” and “how” of the configuration). This configuration data can be used to provide better diagnostic guidance for the diagnostic scanner/tool and its review of the diagnostic data and the generation of resolution tips. The diagnostic scanner/tool uses the configuration data from the configuration/setup tool and its own diagnostic scan data to provide better diagnostics guidance. The diagnostic scanner/tool has access to what went into the system setup and can use that setup information to help guide diagnostics and the generation of relevant and helpful resolution tips for the user.

In a further embodiment, the configuration/setup tool can record and note whether the user decided not to perform a setup step for a component of the system during a setup procedure. For example, if the user is unable or unwilling (due to a variety of reasons) to perform the setup step(s) for a component, the user can skip that step and make a note that, for example, a safety cable is not yet installed (e.g., cable not installed because not delivered yet). Thereafter, the configuration/setup tool will remind the user that the previously incomplete setup step is still remaining to be performed. Thus, if the user is not able to complete all the steps for a setup/configuration, the user is given the opportunity to not perform that step and to record that it wasn't perform (and optionally why) and to be reminded that the setup procedure step remains incomplete. Such configuration data can aid the user in resolving diagnostic issues that, for example, are related to previous configuration/setup procedures that were performed (possibly incompletely).

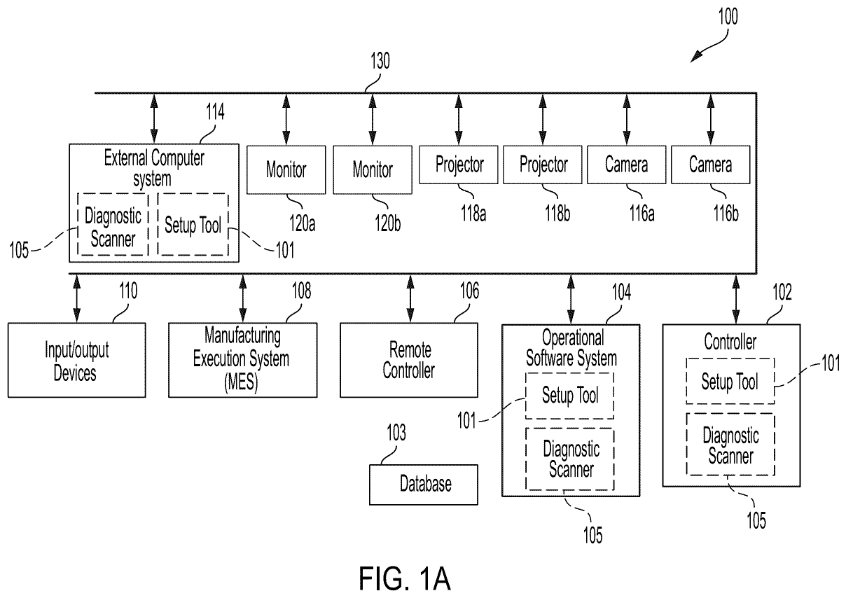

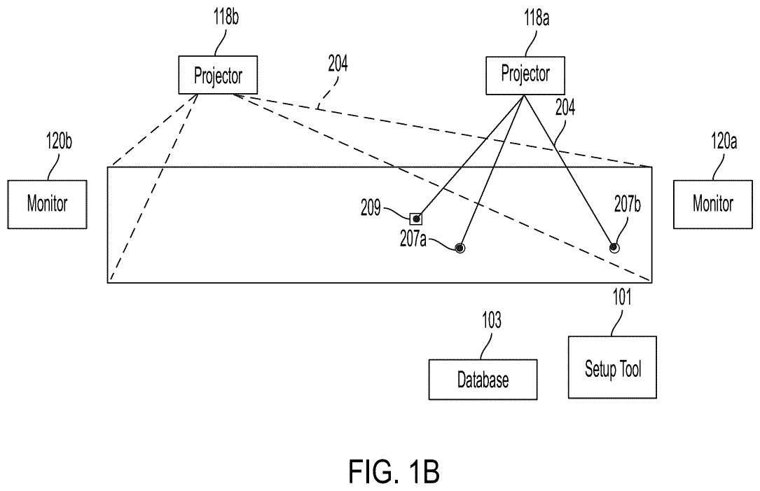

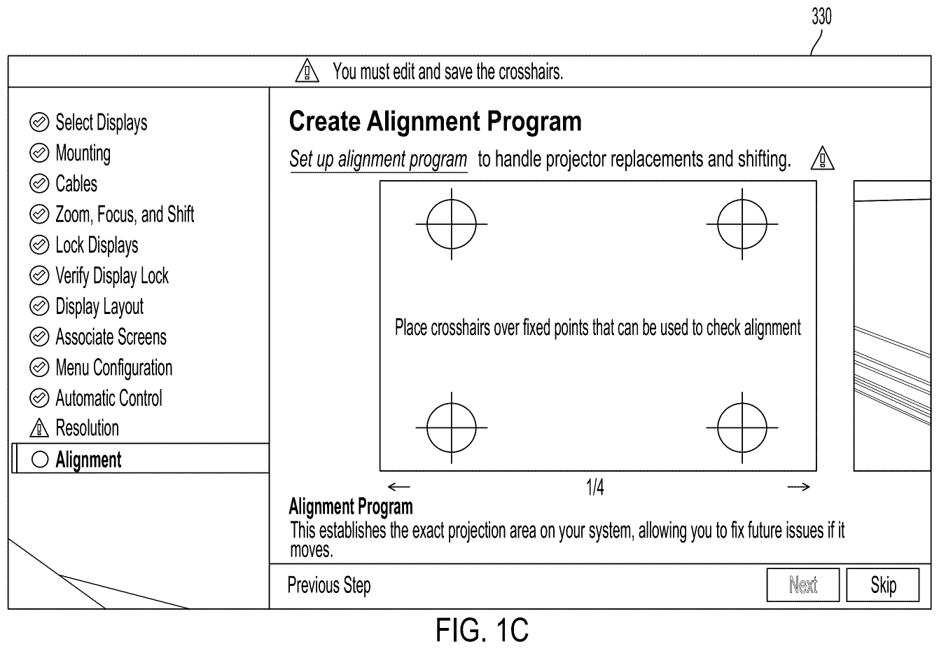

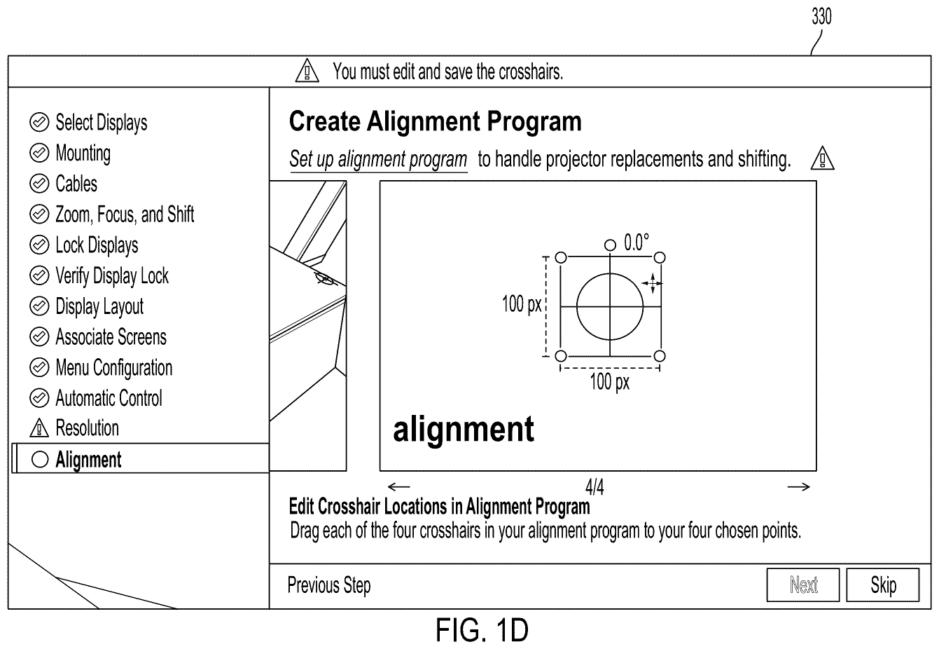

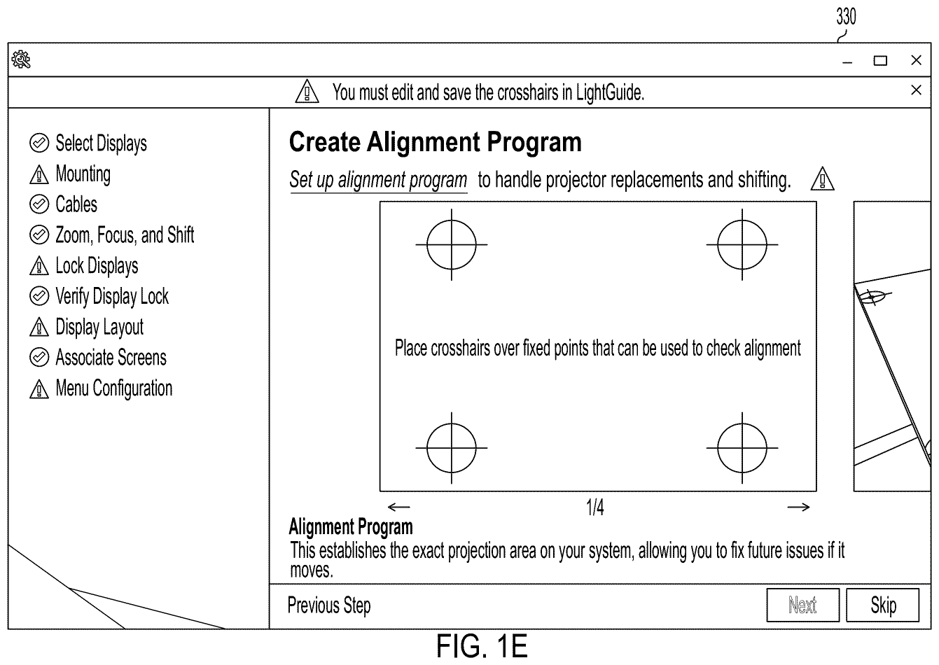

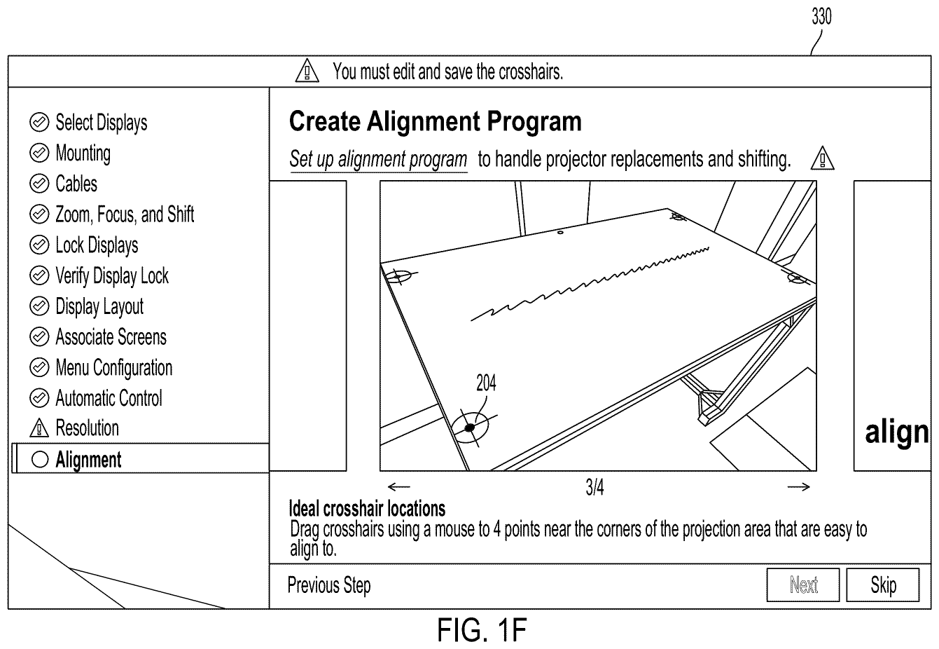

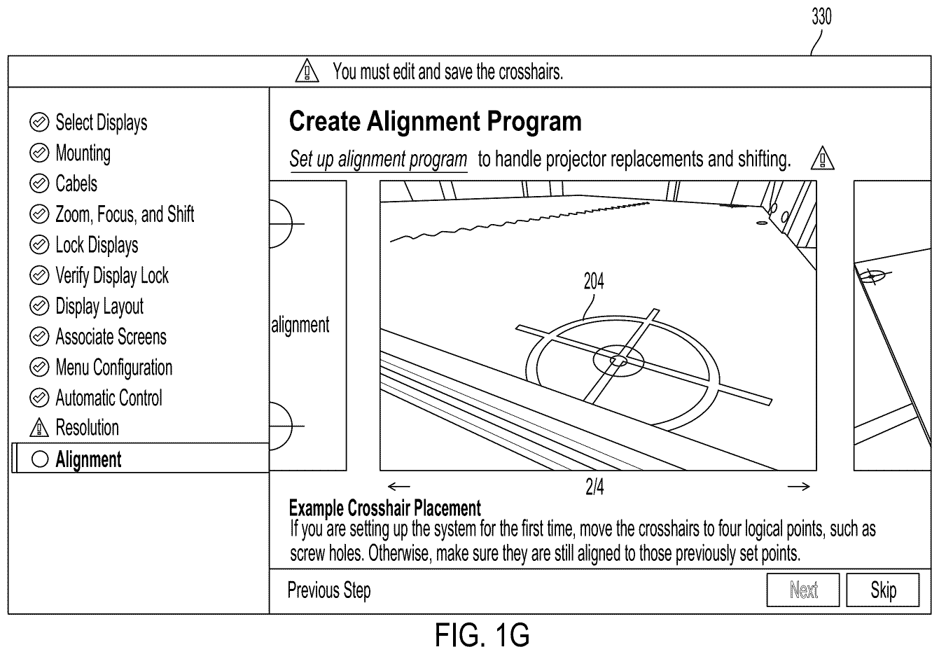

Referring to FIG. 1A, an exemplary light guide system 100 includes a controller 102 for controlling the operation of the light guide system 100, an operational software system 104, an optional remote controller 106, a manufacturing execution system (MES) 108, a plurality of input and/or output devices 110, one or more external computer systems 114, one or more cameras 116, one or more projectors 118, and one or more displays 120. While FIG. 1A illustrates an exemplary two cameras 116a,b, two projectors 118a,b, and two displays 120a,b, any number of cameras 116, projectors 118, and/or displays 120 may be used in the light guide system 100.

It should be understood that the exemplary components of the light guide system 100, such as, the controller 102, the operational software system 104, optional remote controller 106, the MES 108, the input/output devices 110, the external computer systems 114, the cameras 116, the projectors 118, and the monitors 120 are interoperating components. Such components may include or operate in connection with hardware, e.g., one or more memories for storing data and software programs, a component controller for controlling specific functionalities, interacting with the internal/external memory and other systems within the system 100, and input/output interfaces for communicatively coupling between the components.

As also illustrated in FIG. 1A, each of the components of the light guide system 100 are communicatively coupled via a network 130. The network 130 may include conventional wired and wireless network connections. The components may also be additionally or alternatively communicatively coupled via USB, serial cables, video cables, or other media. Such communication means, regardless of source, are hereinafter referred to as the network 130. As discussed herein, the components are interconnected and communicate with each other via the network 130. An exemplary communications protocol between the MES 108 and the vision systems of the controller 102 is MQTT, a network protocol for transporting messages between devices. Other communications protocols could be used. Furthermore, other communications interfaces could be used for communicating between components, such as, Modbus TCP, RESTful Web API, Ethernet/IP, DeviceNET, PROFIBUS, PROFINET, TCP Socket, UDP, RS-232, RS-485, EtherCAT, ActiveMQ, MSMQ, OPC DA, OPC UA, FTP, SFTP, and Windows Communication Foundation (“WCF”).

The light guide system's cameras' video outputs are received and evaluated by the controller 102 that includes one or more vision programs. The vision programs store their data in a memory 108. The controller 102 directs the display of information and instructions via the projectors 118 and/or the monitors 120. As a worker in the work area is performing a directed task, vision tools (cameras 116) are recording the activities within the workstation such that the controller 102, upon receiving and evaluating indications from the vision tools is able to output results to the manufacturing execution system 108. The use and control of a light guide system 100 may be as described in commonly assigned U.S. Pat. No. 7,515,981, which is hereby incorporated herein by reference in its entirety.

Complex systems with multiple component dependencies, such as light guide systems and other systems with multiple components, for these and other similar-systems to function properly, their components need to be configured properly. In an exemplary system with a variety of possible projectors 118 and monitors 120, ensuring the proper set up and configuration of the selected projector/monitor components 118,120 can be difficult. Configuration instructions vary from projector to projector and from manufacture to manufacture. Accordingly, exemplary embodiments include a configuration or set up tool 101 that accesses a database 103 for a set of configuration instructions for setting up a selected projector 118 or monitor 120 of a light guide system 100, such that the selected projector or monitor is properly set up for proper operation within the light guide system 100. The configuration/set up tool (hereinafter “set up tool”) 101 can either automatically perform or guide the user through the necessary steps for performing a configuration that takes into account the particular component to be set up. Thus, a user or customer can configure the system and/or set up and configure a new monitor 120 or projector 118 (or reconfigure an existing monitor 120 or projector 118) using a series of automatic or guided instructions that correspond to the system components to be set up. For example, based on a particular projector 118 to be used with a light guide system 100, a set of corresponding configuration instructions can be used to guide the configuration of the projector 118. As described herein, whether performed by the set up tool 101 in an automatic fashion, or a series of detailed steps presented to the user to manually perform, each step of the configuration process (and the results) can be recorded and the steps verified during the configuration process. The configuration process will not advance or be considered complete until all configuration steps (and/or dependent steps before other configuration steps) have been completed. As discussed herein, a configuration step may be bypassed until later, but the configuration will not be considered complete until all steps are complete and verified.

In one embodiment, machine learning (e.g., a neural network or expert system) is used to analyze and interpret configurations and other data available in the system, including operational data gathered while the system is used over the course of years. End users may contribute to a database of configuration information. A light guide system 100 can use information about device maintenance to communicate and enforce regular preventative maintenance measures such as filter changes, wipe downs, and inspections as a function of time or based on data collected from devices over time. Note that the system can be stand-alone and server-client based, so a central server could gather and analyze individual system data. In one embodiment a particular system is compared to another system or to a particular set of hardware and corresponding configurations. Such will enforce uniform standards within a factory or for a particular customer that wants to use a limited selection of components in order to make maintenance procedures easier and have fewer different spare parts.

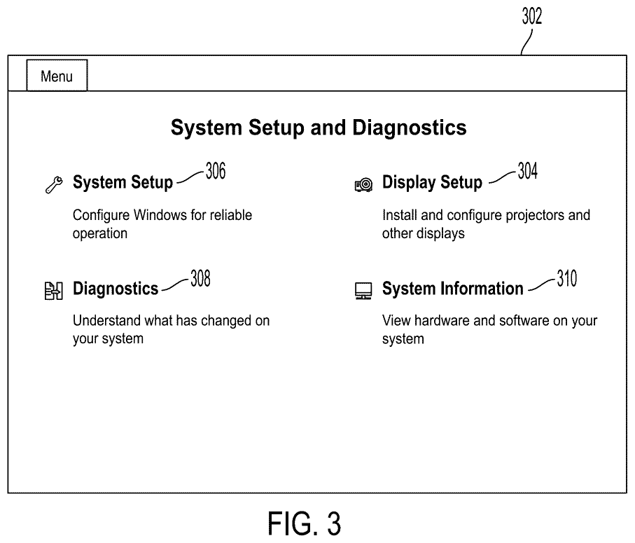

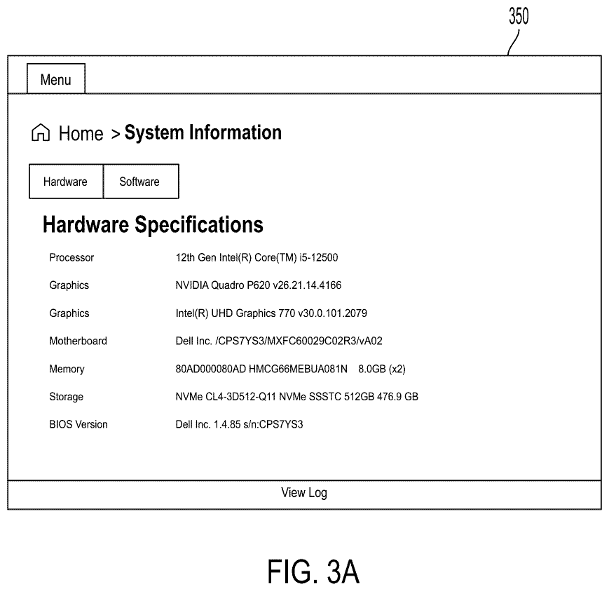

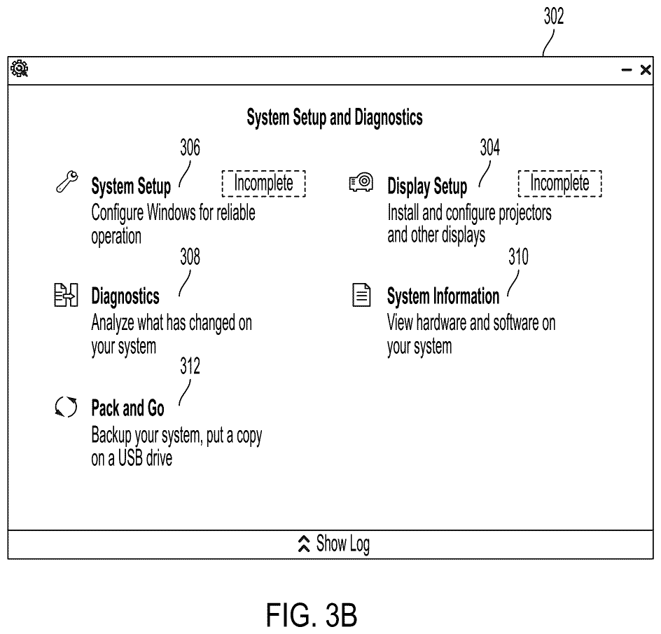

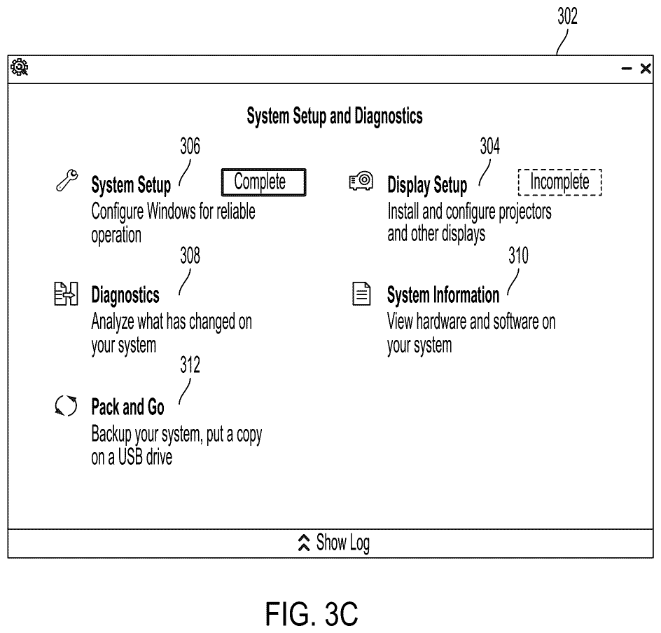

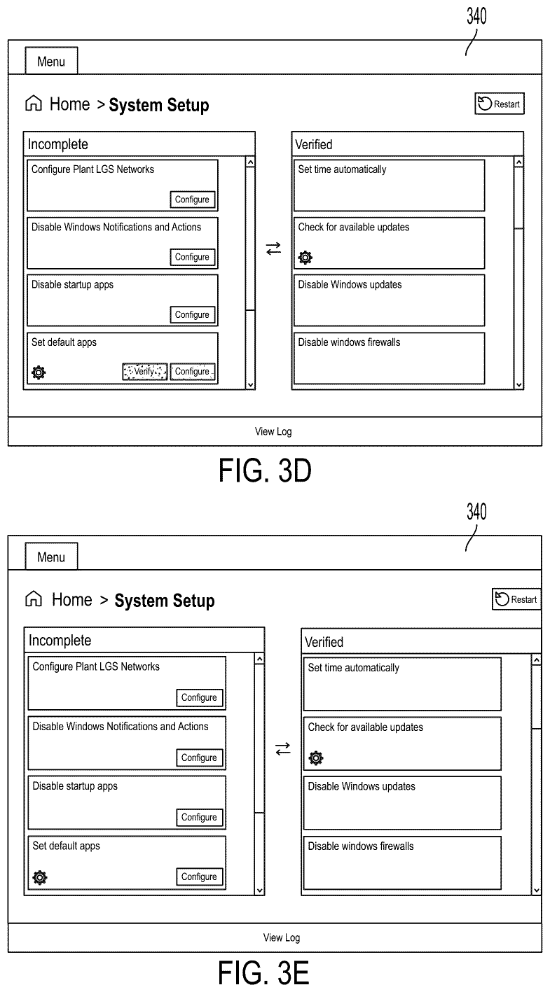

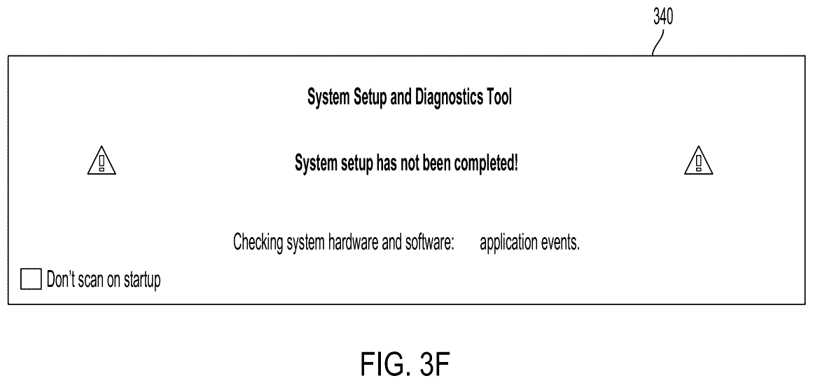

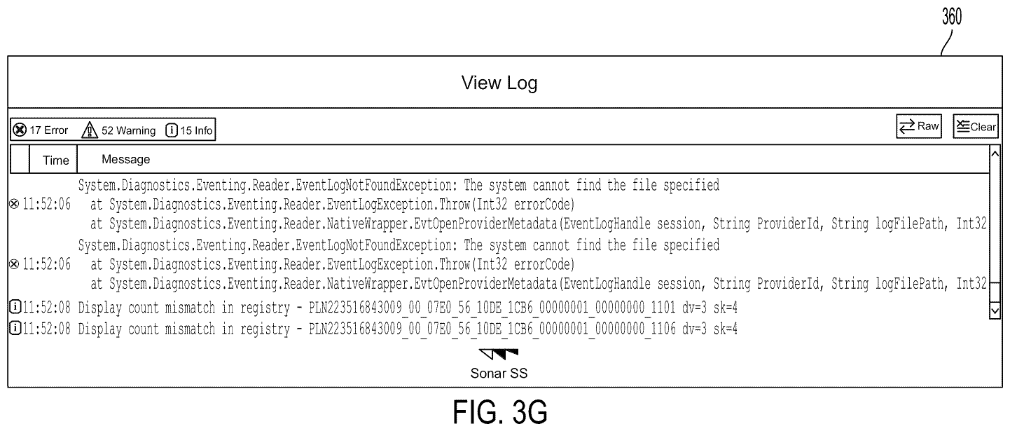

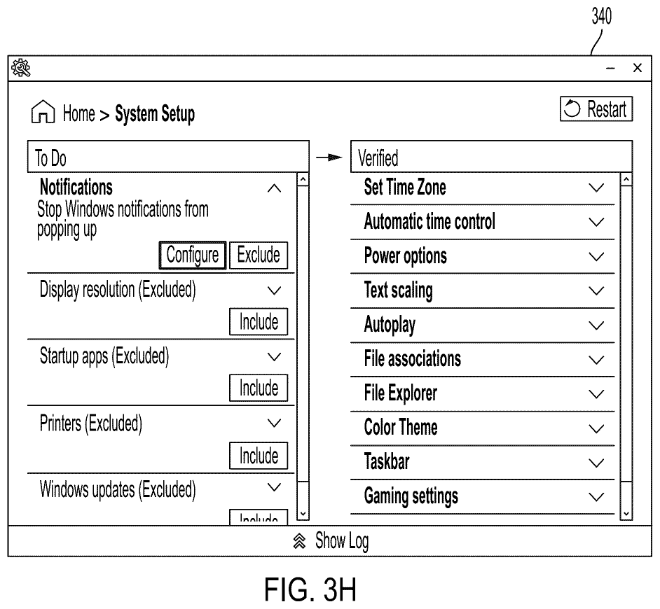

As illustrated in FIG. 1A, one or more setup tools 101 could be integrated into the controller 102, the operational software system 104, and/or the external computer system 114. Other components of the light guide system 100 could also have the setup tool 101 incorporated within them (e.g., the remote controller 106 could also optionally include a setup tool 101). As illustrated in FIGS. 3, 3B, and 3C, the setup tool 101 may be implemented with a separate system setup tool 306 (and associated system setup panel 340) and display setup tool 304 (and associated display setup panel 330). As also discussed herein, one or more diagnostic scanners 105 could be integrated into the controller 102, the operational software system 104, and/or the external computer system 114. Other components of the light guide system 100 could also have the diagnostic scanner 105 incorporated within them (e.g., the remote controller 106 could also optionally include a diagnostic scanner 105). As illustrated in FIGS. 3, 3B, and 3C, the diagnostic scanner 105 may be implemented with a separate system diagnostics tool 308 (and associated diagnostics panel 1702). While the setup tool 101 and the diagnostic scanner 105 are illustrated as separate components, alternatively the setup tool 101 and the diagnostic scanner 105 could be implemented as a combined or integrated setup/diagnostic tool.

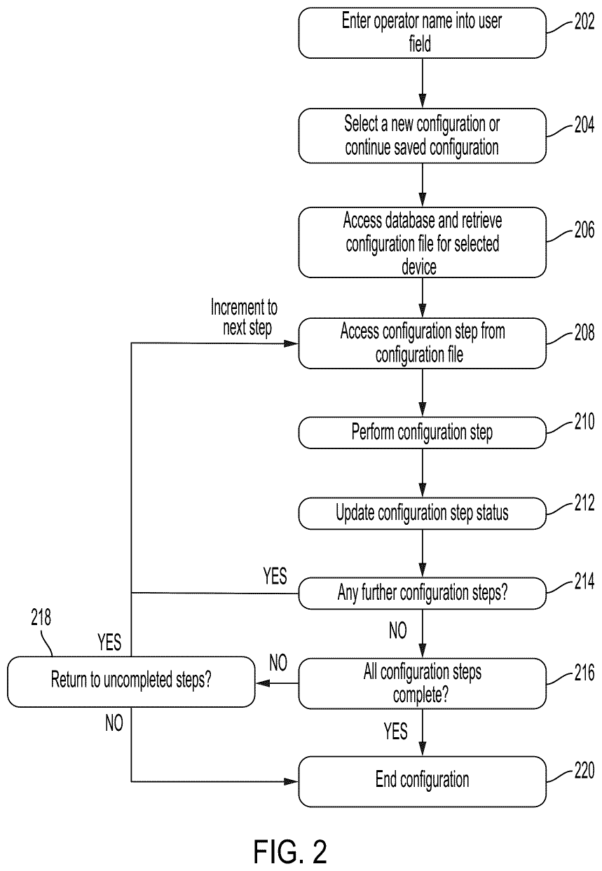

The method illustrated in FIG. 2 allows a user, technician, or IT personnel to setup and configure the components of a light guide system 100. The method provides for the selection of a set of configuration steps for setting up a new (or reconfigured) projector 118 or monitor 120 of a light guide system. In step 202 of FIG. 2, an operator or user's name is entered into a user field to record the name of the individual starting or continuing a configuration procedure. The setup tool 101 accesses or includes a memory that contains a table or database 103. The table/database 103 includes a plurality of configuration files, each configuration file associated with a particular component (e.g., a projector 118) of the light guide system 100. After the user's name has been entered into the user field, the name is recorded in the database 103 to be connected to a new configuration process, a continued configuration process, or a previous configuration process (to be modified or double-checked). Recording the user's identity allows for the recording or tracking of the configuration steps that are carried out during that particular configuration attempt and links them to the user. In step 204 of FIG. 2, either a new configuration or a saved configuration to be continued is selected. The selected configuration will be for the selected system component that needs to be configured (or have its saved configuration completed). It is anticipated that a variety of configurations are possible, for example, configurations may be found in the database 103 for any number of the hardware components of the light guide system (e.g., projectors, monitors, cameras, and computer systems), as well as particular software systems (e.g., Windows operating systems on computers). Verification of configuration steps provides an assurance that the steps are performed correctly (or at all), are monitored, and indicates which steps are complete (as well as providing information related to those steps).

The setup tool 101 can also automatically detect what components the system 100 includes. For those components needing configuration, the setup tool 101 may recognize that a particular component is communicatively connected to the system and is needing configuration (or the completion of a configuration). Thus, when the setup tool 101 is used, the setup tool 101 can display to the user a list of current components as well as identify those components that are in need of configuration. For example, if one of the components is a projector 118, the setup tool 101 would find that projector 118 and find the configuration information for that projector 118. As illustrated in FIG. 1B, an exemplary projection system may include a variety of projectors 118 and monitors 120. Thus, for example, more projectors or monitors can be added, or existing components can be swapped out or moved around and reconfigured. An apparatus and process for configuring one or more displays is described in detail herein.

In step 206 of FIG. 2, the setup tool 101 accesses the database 103 and retrieves the corresponding configuration file(s) for setting up and configuring the selected component. In one embodiment, the database 103 includes configuration files for a variety of possible component models and is configured to provide detailed instructions or automated steps for configuration and operation of components. As discussed herein, the selected configuration file (or files) includes a series of steps, either for the setup tool 101 to perform or to present to the user for manual performance. The database 103 for a particular component (e.g., a projector 118a) may provide one or more of brand, model, warranty information, operational hazards and cautions, warnings with regards to light output, any safety cable requirements, any limitations to component configuration or orientation, lumen output, zoom capabilities, F-stop, focal length, focal distance, number of pixels, limits to a projector's native shift feature, types of available network connections, and periodic preventative maintenance steps, and a dimming schedule to track a shift in brightness output of the pixels, power consumption, Extended Display Identification (“EDID”) information, and available menus). In step 208 of FIG. 2, a configuration step from the selected configuration file is selected. Example configuration steps for system setup can include, for example, checking for Windows software system updates. If the setup tool 101 is unable to perform the software update automatically, the configuration step will direct the user to manually perform the check and is configured to detect whether the Windows software update has been performed. If the check isn't completed or fails, the configuration step will be recorded as “failed” or “incomplete” as necessary. Otherwise, the configuration step will be recorded as “complete.”

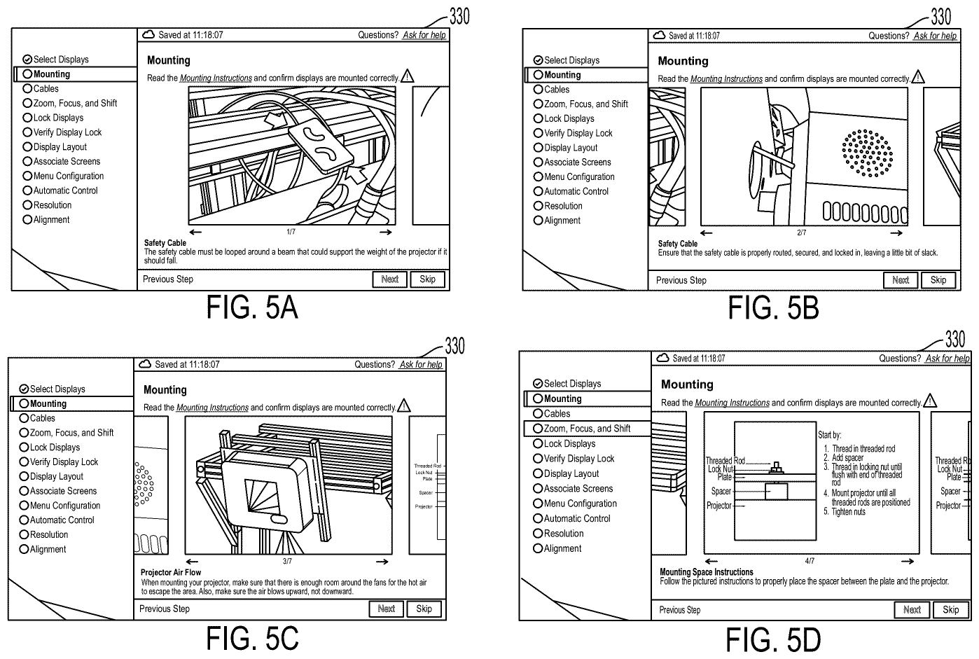

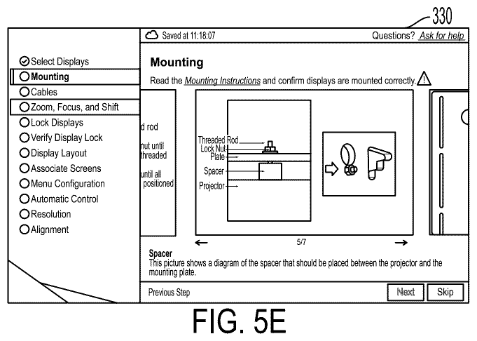

In step 210 of FIG. 2, the configuration step is performed. Example configuration steps for setting up a projector include both physical installation and mounting and hardware/software configurations. For example, such configuration steps can include rules for use (or requirement) for a safety cable when mounting a projector, information about the required spacers, threaded rods, and lock nuts that are to be used and related mounting hole configurations for the particular projector model and manufacturer (see also FIGS. 5A-5E discussed herein). The configuration steps may also provide links or downloads of related documents (e.g., PDF documents) that provide additional information about one or more steps in the configuration. Because each component model will include different hardware, there will be different mounting instructions. The configuration instructions will also include appropriate cabling instructions (e.g., labeled cables with instructions for selection of the proper video port, and selection of an Ethernet connection versus Serial port).

In step 212 of FIG. 2, the progress of the configuration step is updated in the configuration file (e.g., whether the current step was completed and verified, or if not completed, where in the process the step was paused or stopped). A log may also be updated with configuration results data.

In step 214 of FIG. 2, the setup tool 101 determines whether there are any remaining configuration steps to perform. If there are additional steps, the method returns to step 208 of FIG. 2 and the next configuration step is accessed. If there are no further steps, the method continues to step 216 of FIG. 2, where the setup tool 101 determines whether each of the configuration steps have been verified. If one or more steps have not been verified or previously completed (e.g., skipped), the method continues to step 218 of FIG. 2. That is, the configuration process will attempt to finish the configuration and verify each step. In step 218 of FIG. 2, the user is given the opportunity to either return to step 208 of FIG. 2 for the setup tool 101 or the user to perform the remaining configuration steps to be completed and verified. Otherwise, the method continues on to step 220 of FIG. 2. If all the configuration steps have been completed and verified, the method continues to step 220 of FIG. 2. Note that if the process is finished with one or more configuration steps being incomplete and/or unverified, the configuration will be saved as in-progress and incomplete. In one embodiment, the progress data may include a list of the configuration steps still to be performed and/or those steps that were not verified or those steps that are unverified, such as in those steps that were performed but the configuration step failed, or an error was detected. That is, if a configuration step is skipped or left incomplete, the user will not be able to finish the component configuration until the step has been completed and verified.

Referring to FIG. 3, an exemplary setup/diagnostics panel 302 for an exemplary light guide system 100 may include a display setup tool 304 (e.g., for projectors 118 and monitors 120) and a system setup tool 306 used to indicate whether individual displays or other system components are properly configured and verified. FIGS. 3B and 3C illustrate an alternative embodiment with an exemplary “Pack and Go” 312 function for backing up the system (and storing the backup in a selected online or offline location). The display setup tool 304 and system setup tool 306 are also associated with a corresponding display setup panel 330 and system setup panel 340, respectively. As illustrated in FIGS. 3, 3B, and 3C, the setup/diagnostics panel 302 also includes an exemplary diagnostic tool 308 for diagnosing issues related to configuration errors or other troubles. As discussed herein, the diagnostic tool 308 accesses the diagnostic scanner 105. The setup/diagnostics panel 302 also includes an exemplary system information tool 310 for accessing system information. The system information is displayed in an exemplary system information panel 350 illustrated in FIG. 3A).

The system information panel 350 displays exemplary hardware specifications (e.g., specifications for a system processor, graphics card(s), motherboard, memory, storage, and BIOS). If the light guide system (e.g., via the setup/diagnostics panel 302 during a configuration procedure) gets an error, the system can offer to open the diagnostic tool 308 to help troubleshoot and diagnose the error. For example, when there are troubles with the network 130, the diagnostic tool 308 can provide or perform steps to troubleshoot the network error. This system information may also be communicated to a central server for general management and maintenance of multiple systems.

Referring to FIGS. 3B, 3C, 3D, and 3E, an exemplary system setup panel 340 displays a series of system components and whether their configuration has been completed and verified. Note that the system setup panel 340 includes interaction buttons for the user to select which system component (i.e., hardware or software) that they wish to setup. As each component is configured and verified, it will be moved from the left side of the system setup panel 340 to the right side. Referring to FIG. 3F, the system setup panel 340 also displays a message when the user exits from the system setup tool 306 and notifies the user that the system setup has not be completed. As illustrated in FIGS. 3B and 3C, the system setup panel 340 can also be used to indicate that there are still setup tasks to complete (e.g., the system setup and display setup are indicated as “incomplete”). FIG. 3C illustrates that the system setup tasks are now “complete.”

Referring to FIG. 3G, the system setup panel 340 also produces a log, which may be displayed in an exemplary log panel 360. The setup tool 101, as the configuration procedures are being performed, outputs configuration data to the log. The log may include all error and exception data as well as other related data. Other setup and configuration results and data may also be output to the log. As discussed herein, the diagnostics tool 308 of the light guide system 100 accesses or receives the log such that the diagnostics tool 308 can assist in troubleshooting and correcting any errors in the configuration and set up of system components.

In one embodiment, the light guide system 100 (via the operational software system 104, controller 102, remote controller 106, manufacturing execution system (MES) 108 and/or external computer system 114) needs to function without any kind of user administrative rights in associated Windows operating system programs. That is, the operational and configuration capabilities of the light guide system 100 needs to be functional without concern for attaining administrative rights, which would require specific permissions for access. Such rights are often restricted in order to have better security and reliability on production systems, therefore, it is a feature of the light guide system 100 to not have these rights. However, the diagnostic tool 308 needs to run with administrative rights because the diagnostic tool 308 needs to be able to change certain aspects of the Windows operating system that would be restricted otherwise. Therefore, when troubleshooting (via the diagnostic tool 308), administrative rights needs do need to be attained. Because the light guide system 100 does not have administrative rights, the light guide system 100 uses the diagnostic tool 308 (which does have the administrative rights) to do the troubleshooting and correcting. While using the diagnostic tool 308, the user may need to enter a user ID to attain administrative rights. There can also be a mode of operation of the diagnostic tool to run without administrative rights, with the data that is accessible only with administrative rights pre-recorded from the last time it was able to access that specific data.

In one embodiment, the setup tool 101 (e.g., the display setup tool 304 or the system setup tool 306) of the light guide system 100 sends over logs and relevant information for the diagnostic tool 308 to troubleshoot the issue. Even if the diagnostic tool 308 is unable to troubleshoot the issue, the diagnostic tool 308 and/or the light guide system 100 can put all the relevant information together into a file (e.g., a zip file) that can then be sent to the manufacturer or some other entity for further analysis and possible correction. This avoids requiring the user (or others) to decide what files or logs are to be sent for review/analysis. The data collection (i.e., preparation of the logs and relevant information) can be automated for a particular help request to the diagnostic tool 308.

In another embodiment, the diagnostic tool 308 also creates a service ticket for tracking the configuration issue or error, such that the service ticket information is sent to the manufacturer along with the collected data.

Referring to FIGS. 3H and 3I, the system setup panel 340 also handles operating system configurations. The system setup panel 340 can also provide for a verification of software components and allows the user to configure outstanding items or excludes those items from the software check. Such items listed in the system setup panel 340 can also be expanded with the “v” and “A” chevrons to see more information about the particular configuration or configuration item. As illustrated in FIG. 3I, choosing to exclude a configuration item results in a “popup warning” panel 342 that explains the consequences of this decision before the user confirms the decision. That is, FIG. 31 illustrates a warning to the user who is choosing to exclude a necessary configuration step from the setup. This would happen if, for example, there is a customer policy that prevents the system from following what is considered a “best practice.”

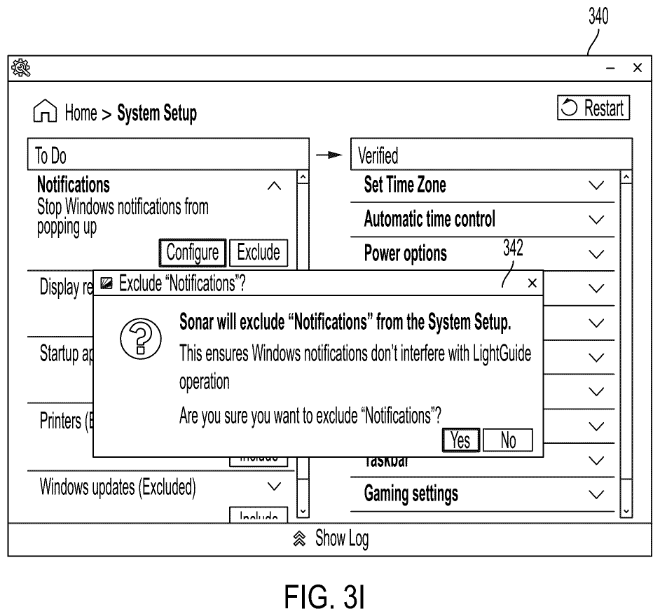

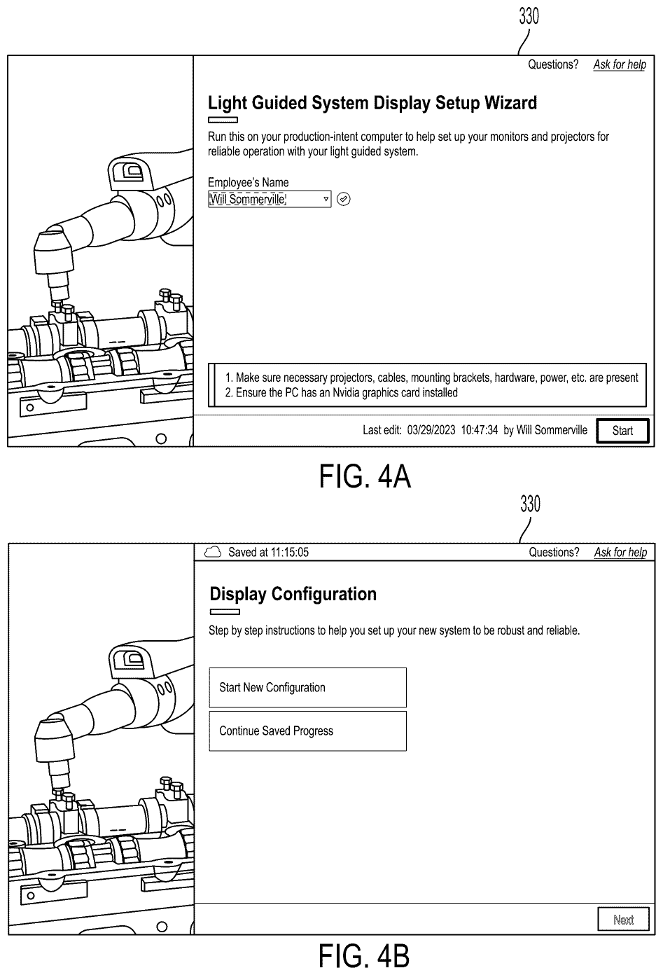

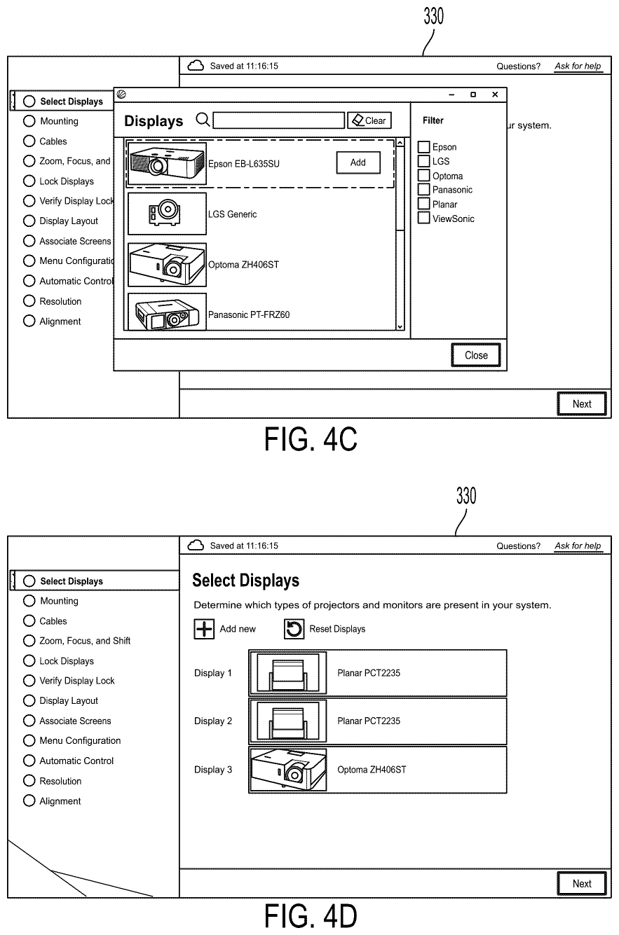

Referring to FIGS. 4-12, an exemplary display setup panel 330 provides an interactive display providing display setup and configuration instructions for setting up new or reconfigured monitors 120 and/or projectors 118. As discussed herein and illustrated in FIG. 4A, the display setup panel 330 begins with a user sign-in screen for the user to sign in. Such user sign-in procedures, in requiring a user to “sign in” provides for a record to be kept of who performed each configuration item/step and when. When a user is signing in for the first time, they are walked through a procedure for supplying their user information. Afterwards, the user merely has to scroll through a drop-down list of user names to select from. The selection of a username could optionally be coupled with security access such that each user is provided with credentialled access to their respective user information. FIG. 4B illustrates an exemplary selection between a new display configuration and continuing a saved configuration. FIG. 4C illustrates an exemplary selection screen when installing and setting up a new display. As illustrated in FIG. 4C, the user may be given a list of possible displays to select from for the new display (whether a projector 118 or monitor 120). As illustrated in FIGS. 4-12, as the configuration steps displayed in the display setup panel 330 are completed, a green checkbox will indicate that the step has been successfully completed and verified.

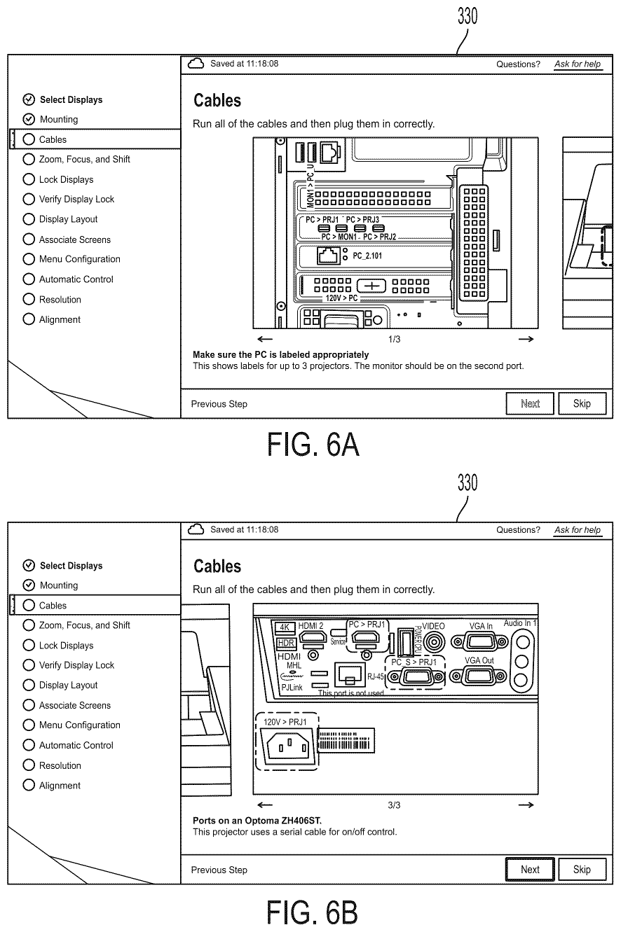

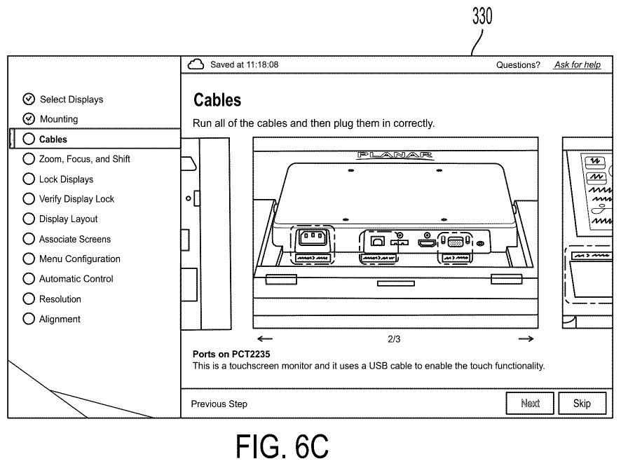

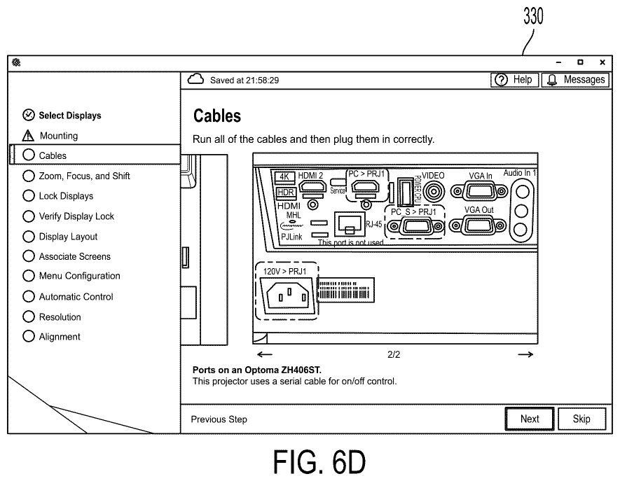

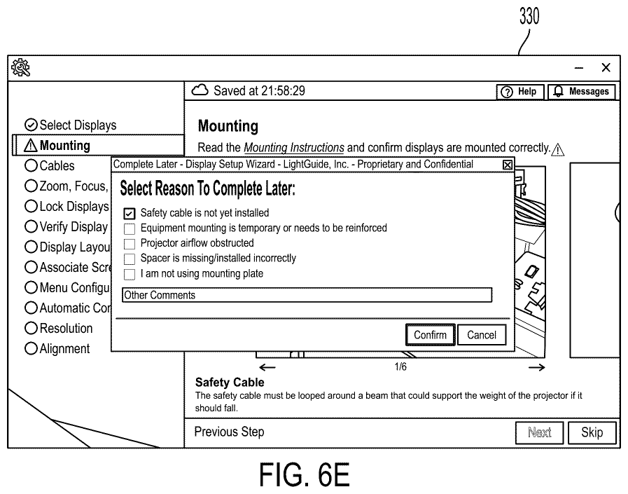

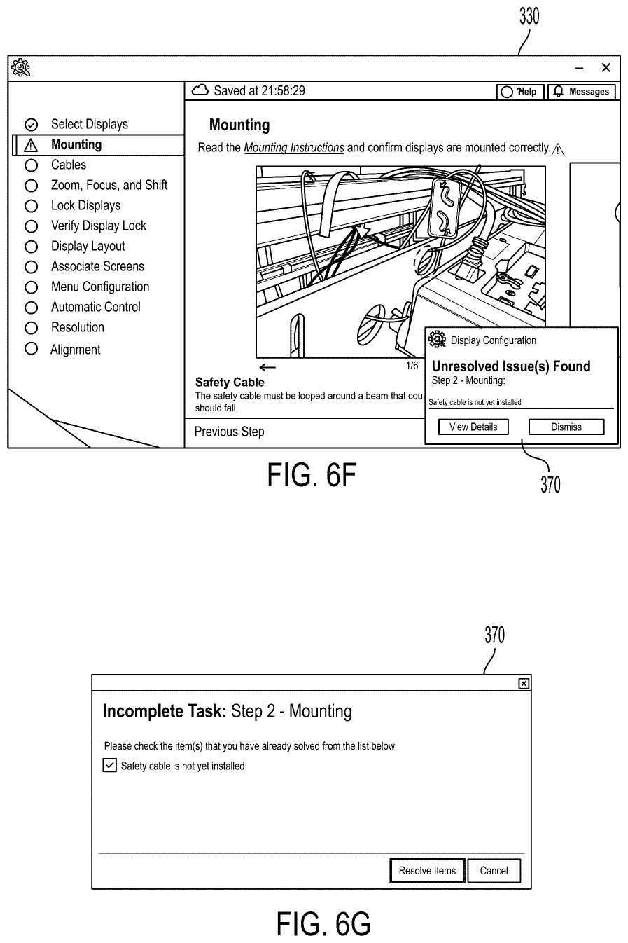

Referring to FIGS. 5A-5E, the display setup panel 330 includes mounting instructions for mounting the selected display. As also discussed above in step 210 of FIG. 2, the display setup panel 330 includes a series of mounting steps. For example, in FIG. 5A, the display setup panel 330 displays exemplary safety cable instructions, while FIGS. 5B-5D illustrate physical mounting instructions for the display being set up. Such instructions can include, for example, rules for use (or requirement) for a safety cable when mounting a projector, information about the required spacers, threaded rods, and lock nuts that are to be used (see FIGS. 5D and 5E) and related mounting hole configurations for the particular projector model and manufacturer. The configuration steps may also provide links or downloads of related documents (e.g., PDF documents) that provide additional information about one or more steps in the configuration. Because each component model will include different hardware, there will be different mounting instructions (see FIG. 6).

Referring to FIGS. 6A-6C, the display setup panel 330 includes cabling instructions. Such instructions may include appropriate cable attachment instructions (e.g., labeled cables with instructions for selection of the proper video port, and selection of an Ethernet connection versus Serial port) (see FIGS. 6B and 6C). As illustrated in FIGS. 6B and 6D, many of the configuration steps can provide specific help for the configuration of the actual system components. For example, the configuration step can include labeling specific to a particular component model (e.g., a particular model). FIG. 6E illustrates that during the display setup, a user can skip any step and note the specific part of the step that the user could not (or did not) complete (each configuration step may have up to a dozen specific tasks). The common issues (for failing to complete a configuration step) can be listed as checkboxes (see FIG. 6E) so that the user does not have to manually type in the issue. Optionally, the user can manually type in a reason for not completing a configuration step or substep. As illustrated in FIGS. 6F and 6G, if there were any exceptions noted in the past on that system, during subsequent configuration runs, those exceptions will appear in the corner of the display panel 330 as an exception panel 370. The user is able to view details of the exception (see FIG. 6G) and resolve them independently. This ensures that captured open items are remembered and dealt with.

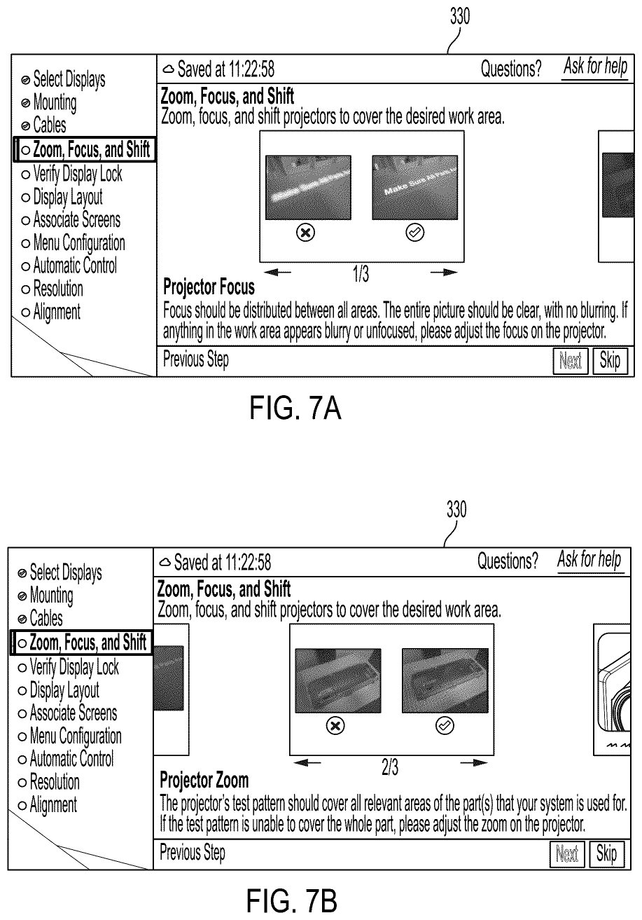

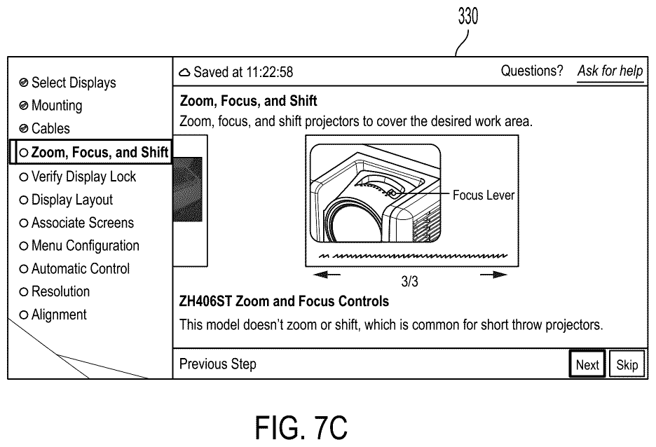

Referring to FIGS. 7A-7C, the display setup panel 330 next includes zoom, focus, and shift configuration and verification of those capabilities associated with the display being configured. FIGS. 7A and 7B illustrate instructions that provide reference images for the user to verify the focus of the display. The configuration step also includes directing the user to the associated shift dial or operator interface tools for adjusting the projector such that the projector or monitor may be properly focused (see FIG. 7C).

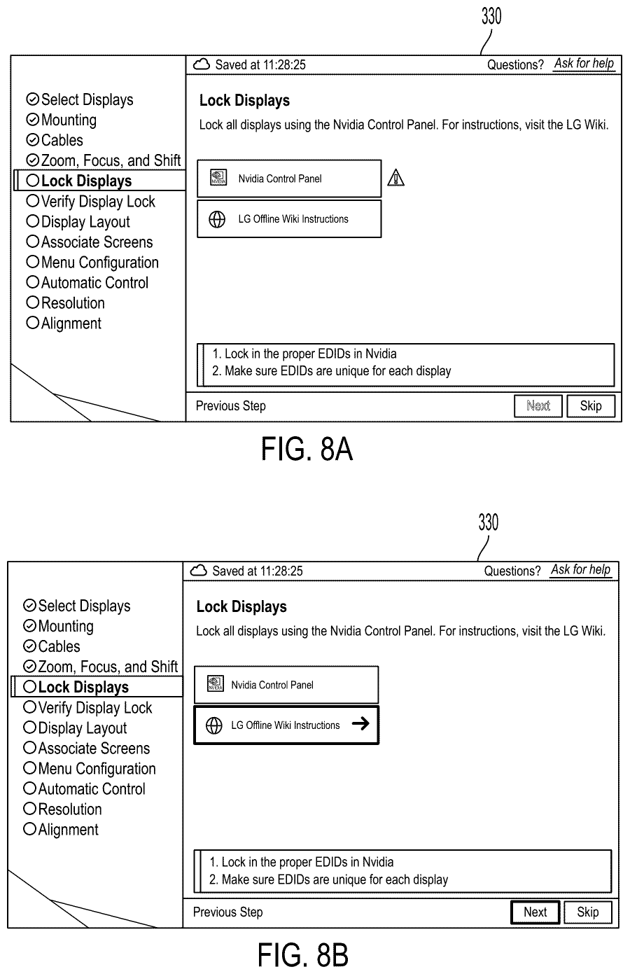

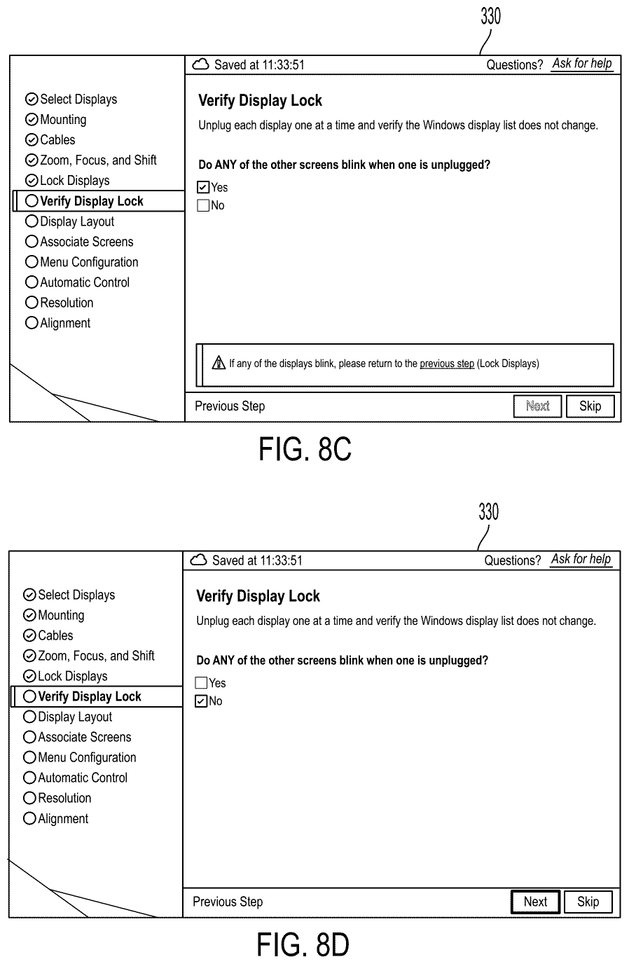

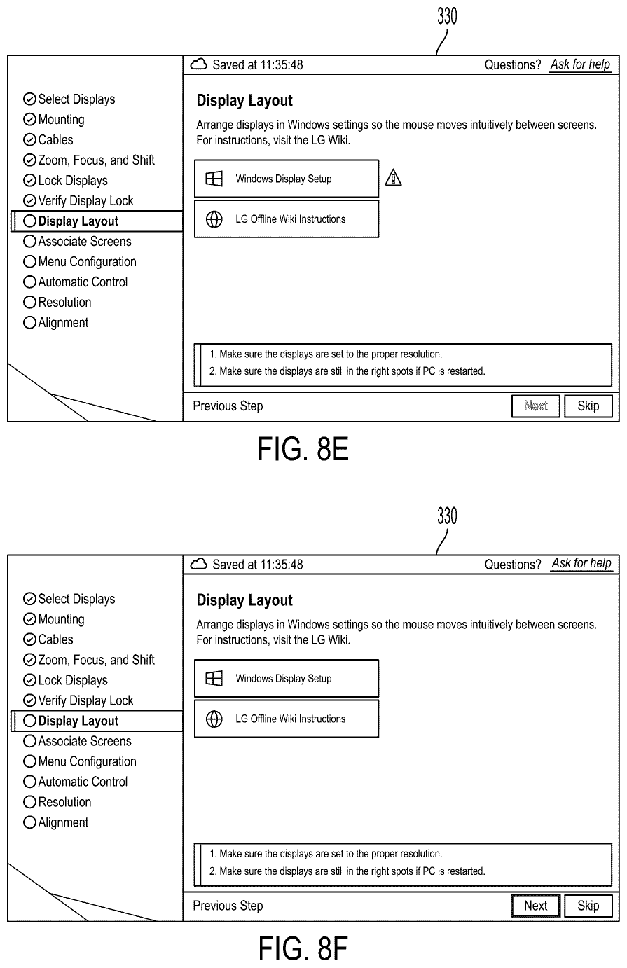

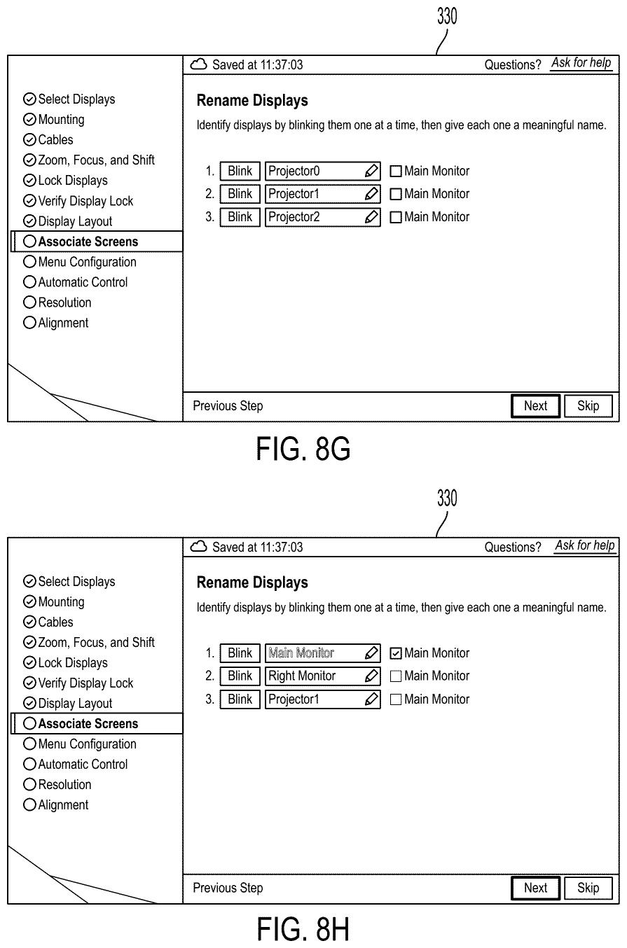

Referring to FIGS. 8A-8D, the display setup panel 330 includes instructions for configuring a graphics card (e.g., from the operational software system 104, the controller 102, and/or other computer systems) for a particular projector 118 or monitor 120. As part of the graphics card configuration, the graphics card may be locked or assigned to the projector. FIGS. 8A and 8B illustrate instructions for locking a particular display. Once the graphics card(s) is configured to the display, disconnecting the display will not causes software issues (e.g., the Windows operating system will not notice when the projector or monitor is unplugged and/or powered down and then reconnected and powered up).

The display setup panel 330 displays configuration information of the graphic card(s) and projector(s) 118 and monitor(s) 120, and may also include a graphics layout visually demonstrating how the monitors and projectors are arranged and assigned (see FIG. 4D). The different projectors and monitors will each be assigned a unique name and identified accordingly. FIGS. 8C and 8D illustrate the display setup panel 330 displaying display lock verifications. Note that there are user selected interactions in the instructions displayed by the display setup panel 330.

Referring to FIGS. 8E and 8F, the display setup panel 330 next displays information related to display layout. Referring to FIGS. 8G and 8H, the display setup panel 330 also provides an opportunity for the user to configure the displays (projectors 118 and monitors 120) of the system. For example, the display setup panel 330 provides a means to associate a particular display as a main monitor, another as a right or left monitor, and a projector (see FIG. 8H). It is noted that each step of the display setup configuration cannot advance until some minimal amount of engagement is recorded (by the setup tool 101). As illustrated in FIG. 8A, the user must open a manufacture control panel (e.g., Nvidia display control panel). Other pages might require the user to click through and view all images in a slide show, etc.

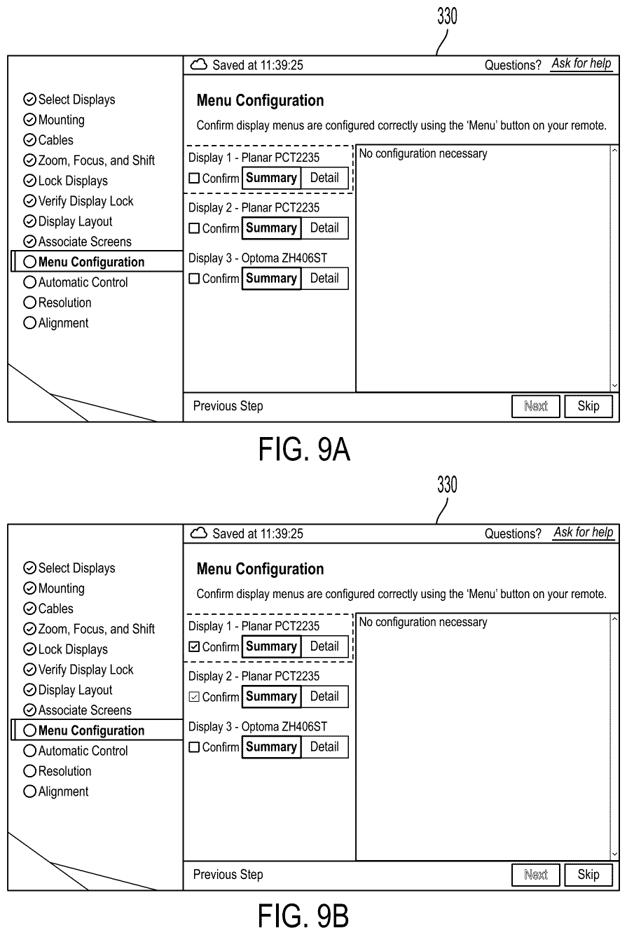

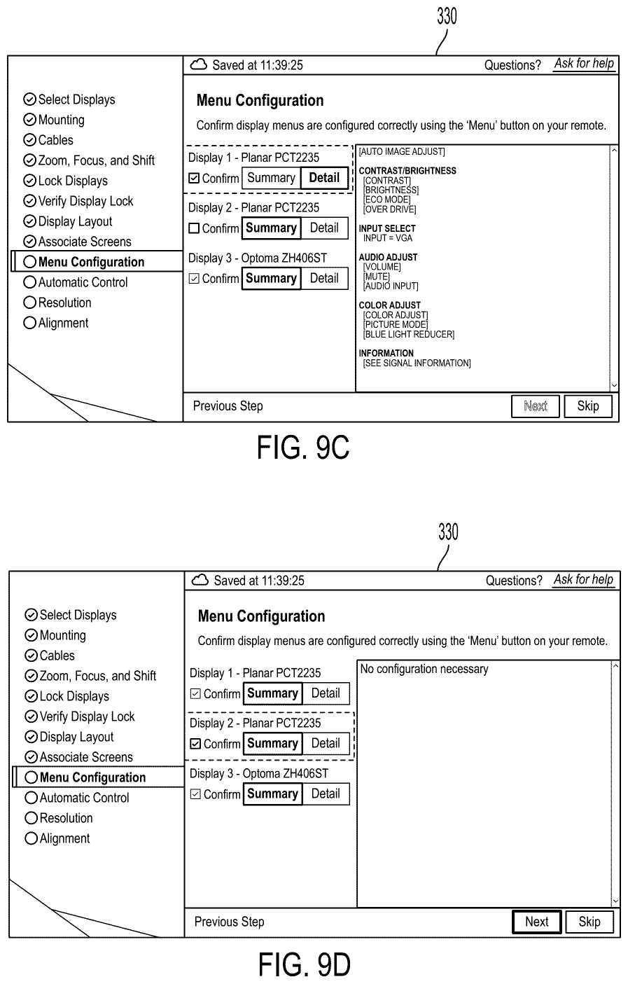

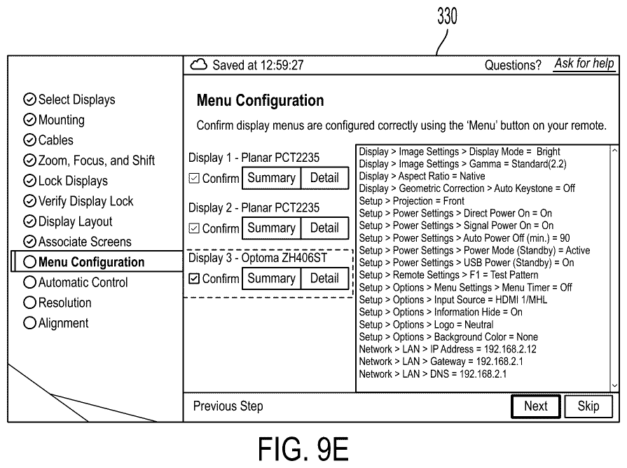

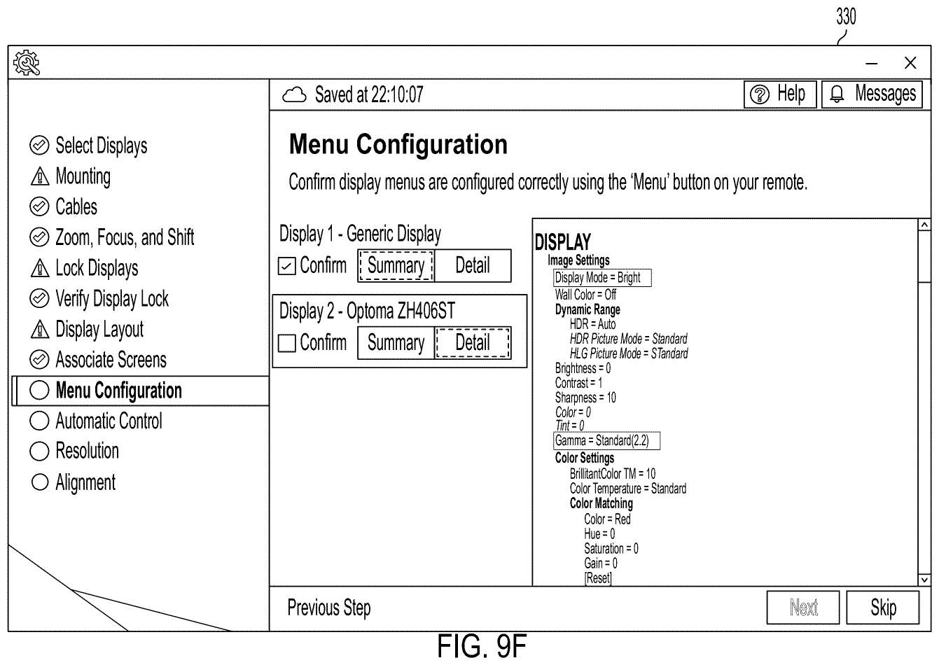

Referring to FIGS. 9A-9E, the display setup panel 330 may display a menu configuration for the display, with FIGS. 9A through 9E illustrating the steps to configuration the menus of the display. Such that for a given projector (e.g., projector 118a), the display setup panel 330 of the setup tool 101 provides the user with a list of all the possible menu items used in the remote control of the projector 118a. Items that need to be updated or changed can be highlighted. These items include the IP address of the projector 118a and power settings (because without proper power settings, the projector 118a may not be able to monitor its Ethernet port while powered down). The setup tool 101 may also provide a summary view of the items that need to be changed to configure the component for remote operation, e.g., the ability to send ON and OFF commands to the light guide components. Each component will have particular settings that need to be selected for proper remote operation and control. Thus, the setup tool 101 provides for an automatic configuration where possible but otherwise provides the user with what they need to know to manually configure and set up the hardware. FIGS. 9A-9E illustrate exemplary projector menu settings that must be configured using a remote control. These settings are specific to the projector model and this information is recorded in separate configuration files that are provided as a part of an exemplary pre-configuration procedure.

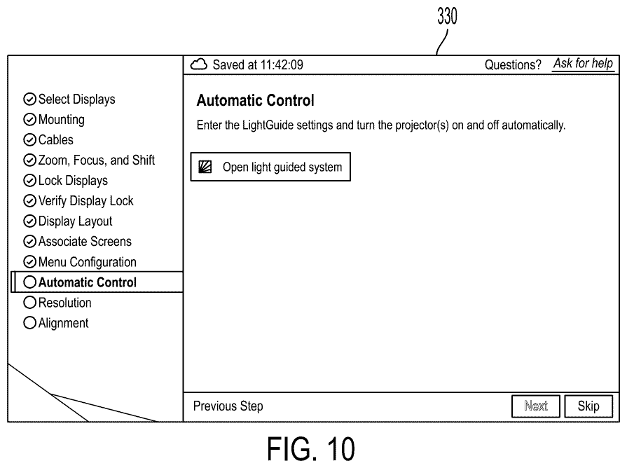

Referring to FIG. 10, the display setup panel's configuration steps also include as part of its configuration steps, the option of letting the system 100 automatically turn on the displays (e.g., the projector(s) 118). In one embodiment, the system includes the ability to control projector ON/OFF states, which may be necessary for long term operation of the system, and extending the useful life of the projectors 118. By having the user set up this link, there is the possibility of enabling automatic, live monitoring of errors and warnings that can be reported by the projector to the system 100. Furthermore, some projector models can even said emails when they require service. While embodiments of the present invention can tell the user to set up such functionality, the database of projector information may allow the system to automatically set these links, in some cases with very little human intervention.

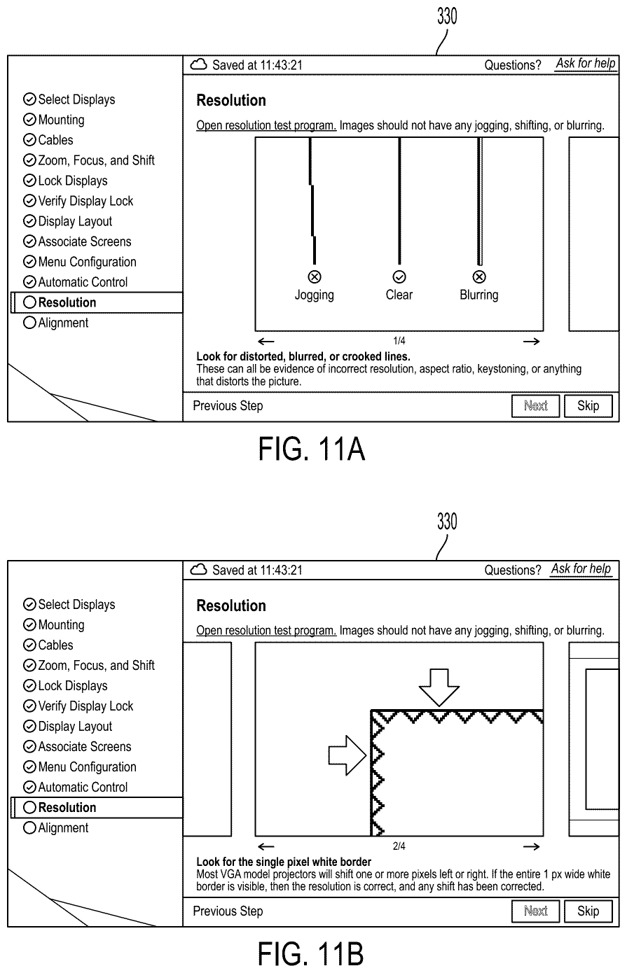

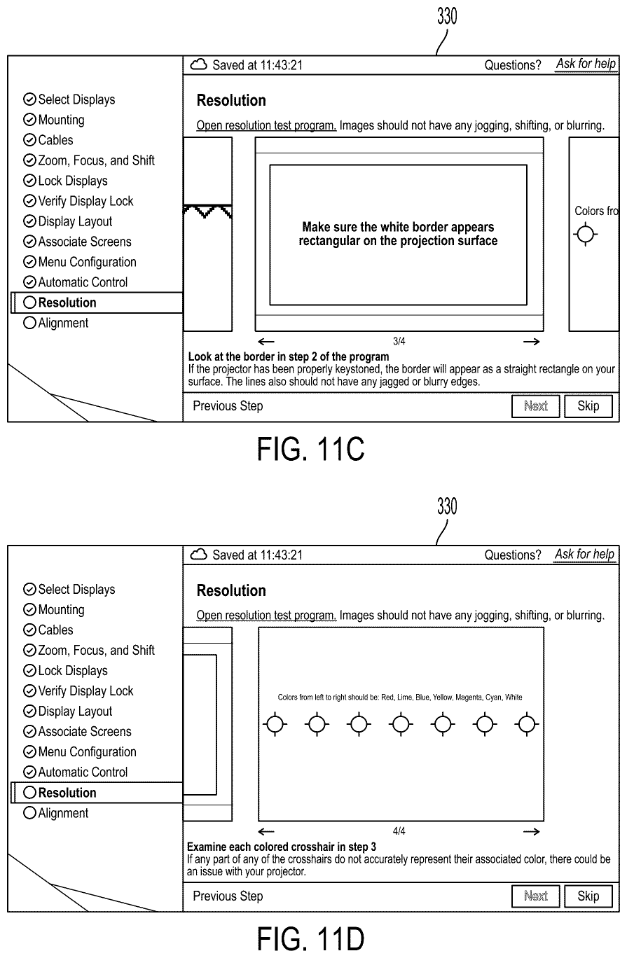

Referring to FIGS. 11A-D, the display setup panel's configuration steps include a confirmation of the display's resolution, such that the image quality of the projector may be verified by viewing a displayed border along selected portions of the work area to ensure its output is correct or adjusted as needed. Such adjustments can ensure the projected images are not cropped and that each color is displayed properly. As illustrated in FIG. 11A, a verification of the display's resolution may include consideration of whether the displayed lines are distorted, blurred, or crooked. Such resolution confirmation steps enable fine details to be projected with high visibility. For example, if there are keystone correction or other geometric corrections of the projected image, then the individual pixels to be projected will not correspond to real pixels on the projector, causing pixels to blur together and reduce visibility and clarity. In FIGS. 11B and 11C, the display setup panel 330 includes a resolution verification step that includes instructions for viewing an edged border around a projection surface. Lastly, as illustrated in FIG. 11D, the display setup panel 330 includes consideration of the projected colors and allows the user to verify whether the displayed colors are accurately representing their associated color.

Referring to FIGS. 1C-1G, the display setup panel 330 displays alignment instructions to finish the configuration and setup of the display (monitor or projector). This is to ensure that any future zoom/shift/rotation of the projector can be corrected back to the original state. Also, if a projector is replaced, the new projector can be adjusted to create the same images in the same places as the old projector without recalibration of the images. Finally, this is useful when a customer suspects that a projector has shifted, so that the user can quickly know whether it did shift or whether maybe the parts changed or moved.

Referring to FIGS. 1B-1G, the exemplary projector configuration steps displayed on the display setup panel 330 include procedures for aligning the projector with respect to a worksurface. As illustrated in FIGS. 1C and 1D, the alignment procedure includes accessing or creating an alignment program for projecting a series of crosshairs 204 that can be placed on the corners of a table or upon landmark locations 207a,b and 209 or other set features on the table (see FIGS. 1B, 1E, 1F, and 1G). While FIG. 1B illustrates the projector 118b displaying crosshairs 204 on the four corners of the work surface and the projector 118a displaying crosshairs 204 on landmark locations 207, either collection of set points may be used (or a combination of them). This ensures that each projector 118 will be properly aligned to the worksurface the same way each time. Once the crosshairs 204 in the alignment program panel 320 are properly defined (see FIGS. 1C and 1D) and positioned (see FIGS. 1F and 1G), the projector 118 is properly aligned with respect to the workspace. This allows the user to ensure that the projector 118 has not been shifted. By having the projector 118 align to a set orientation with respect to the workspace, the user doesn't need to adjust the work instructions (e.g., from the manufacturing execution system (MES) 108) that are projected by the projector 118 during manufacturing steps. In one embodiment, the setup tool 101 in executing the projector configuration steps will utilize a system's operating system to perform particular tasks. The setup tool 101 will look for evidence that the user completed those tasks by reading files that are saved by the system OS. The projector configuration process proactively sets up a tool that is very useful if the user (or another) has to troubleshoot projector issues in the future. This a way that the setup tool 101 aids or works in conjunction with the diagnostic scanner 105.

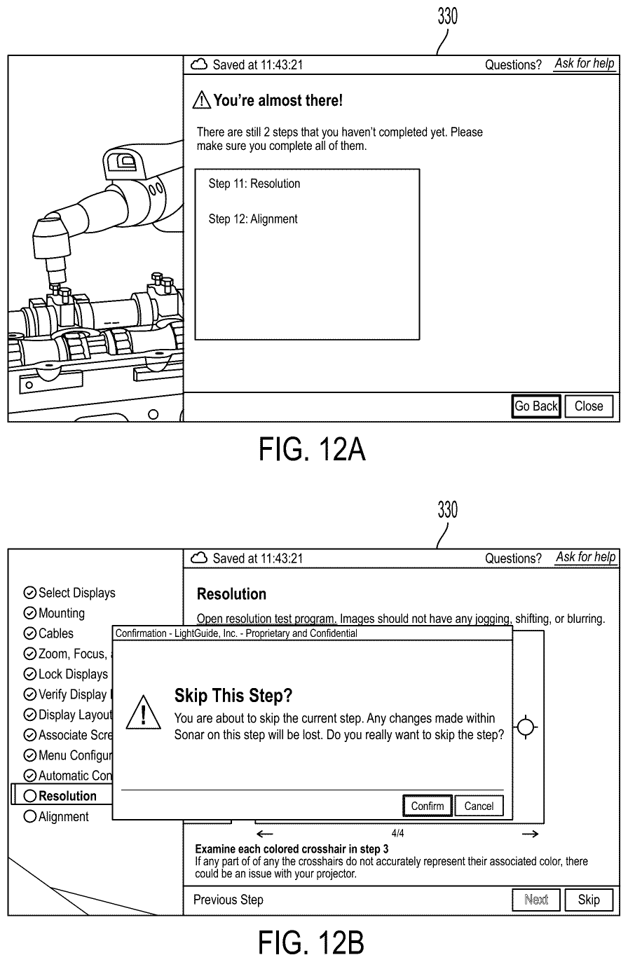

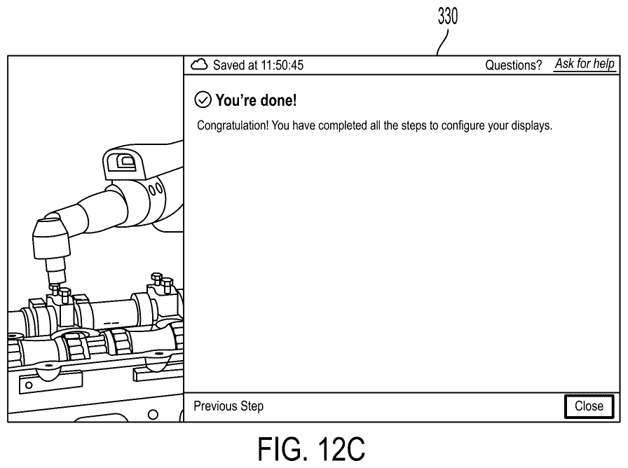

Referring to FIGS. 12A-C, the display setup panel 330 thus displays information related to the process of display configuration. For example, in FIG. 12A, an indication is given to the user that only the resolution and alignment configuration steps are remaining. In FIG. 12B, the display setup panel 330 illustrates a display presented to the user when a step is bypassed or skipped. This display and confirmation interaction confirms that the configuration step in question is to be skipped (for the moment). Lastly, FIG. 12C illustrates the display setup panel 330 displaying an exemplary message that the display configuration is complete.

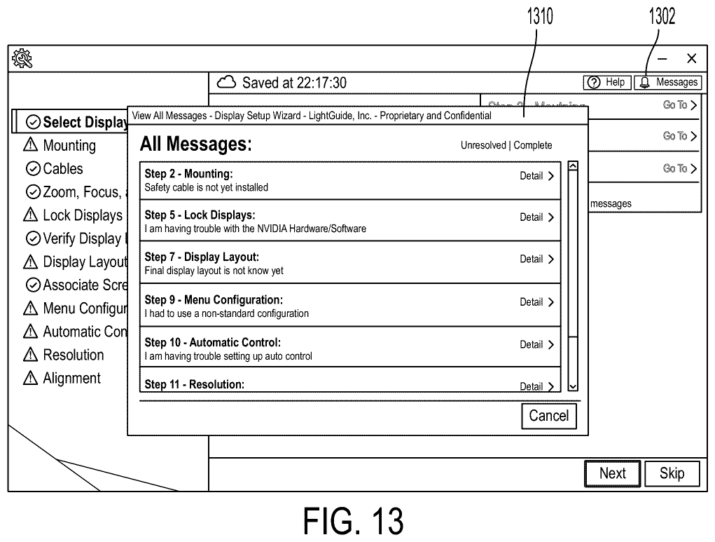

Referring to FIG. 13, an exemplary message board in the display setup panel 330 will display content in a “popup” that lists the skipped items, allowing the user to navigate to them quickly to resolve them, rather than go through every step to find those steps that were skipped. As illustrated in FIG. 13, a user selecting the “Messages” button 1302 will bring up the messages panel 1310 for user review. The messages can be used to provide contextual information with regards to those portions that were “skipped.” For example, in the skipped step “step 2—mounting,” the step was skipped because the requires safety cable was not yet installed. In the skipped step “step 5—lock displays,” the user did not complete the step and notes “I am having trouble with the NVIDIA hardware/software.” Such contextual information can be useful to continue the skipped step. This sort of contextual information can also be useful for the diagnostic scanner 105 in evaluating the diagnostic data and providing useful tips for resolving any issues (e.g., the tip can take into account not just whether there was difficulty with the initial configuration step, but who had the difficulty, and what happened, allowing for a more holistic approach to helping resolve the issue).

### Diagnostic Scanning of System Components:

In one exemplary embodiment, the setup tool 101 works in conjunction with the diagnostic scanner 105 to provide configuration records to the diagnostic scanner to aid the diagnostic scanner 105 in performing a diagnostic scan of the system components. Such configuration records can be very helpful in complex systems with multiple component dependencies, such as light guide systems and other systems with, for example, network-connected components. For these and other similar systems to function properly, their interconnected components need to be functioning properly, communicating with each other (and external systems), be properly configure, and running the correct software version(s) and correct software driver(s). With respect to diagnostic scanning of a complex system, of highest importance are conditions that might impact a complex, configurable, multi-component system with hardware dependencies, configuration dependencies, and driver dependencies. Such functionality and configurations can be difficult to assess. While the information with respect to functionality and configuration data/state may be available, the information may be difficult to find or understand.

Accordingly, exemplary embodiments include the diagnostic scanner 105 that scans a system's components, looks for changes (as compared to a selected previous scan or a baseline scan) and ranks those changes according to predetermined assessed levels of “weirdness” and/or “severity.” An exemplary diagnostic scanner 105 can be accessed via the diagnostics 308 found in the setup/diagnostics panel 302 illustrated in FIGS. 3, 3B, and 3C. Assessing weirdness or oddity and severity are discussed in detail herein. For example, the noted differences between the current system and a previous scan can be sorted such that the more severe or unusual differences are sorted to the top of the list. Thus, a user or customer can scan a system during a regularly scheduling scanning session or because of operational issues to look for changes in the operational status or state of the system. In scanning a component, the diagnostic scanner 105 scans the hardware and software of the component, such as, drivers, configurations, settings files, Windows registry, a BIOS, network devices, USB devices, serial devices, display devices, various installed software, various error and event logs, the file system, hashes of key files, available dates, and anything else that is accessible to the diagnostic scanner 105.

For example, the diagnostic scan can determine whether a component's motherboard has been changed, whether there have been any graphics hardware, software or driver changes. The diagnostic scan may also check for dependency issues related to changes in network settings, driver files, configuration files, and/or work instruction files. If there are detected changes from a reference scan, the detected change will be given a severity ranking and an oddity ranking. Any detected change that would affect the user/operational experience will be given a severity ranking and oddity ranking. The detected changes can also be arranged in a ranked order such that the most critical changes (or most in need of correction) are grouped and presented together, e.g., at the top of a list. While the diagnostic scanner 105 is configured to automatically scan a component's hardware/software, there may be specific tests or reviews that a user will be enlisted or requested to perform. Such manual scans or checks can include things that cannot be automatically scanned by the diagnostic scanner 105. For example, the diagnostic scanner 105 will ask for a user to manually perform a scan that visually checks whether power/data cables are fully connected or whether indicator lights are on for various devices.

As illustrated in FIG. 1A (and discussed herein), one or more diagnostic scanners 105 could be integrated into the controller 102, the operational software system 104, and/or the external computer system 114. Other components of the light guide system 100 could also have the diagnostic scanner 105 incorporated within them (e.g., the remote controller 106 could also optionally include a diagnostic scanner 105).

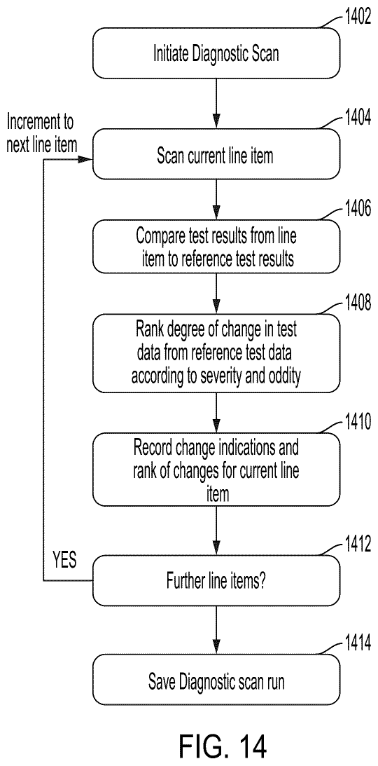

The method illustrated in FIG. 14 allows a user, technician, or IT personnel to troubleshoot a complex system when that system is not functioning as expected. The method provides for a diagnostic scan of the components of the system to determine what has changed from an earlier scan of the system. In step 1402 of FIG. 14, a diagnostic scan is initiated. A diagnostic scan can be initiated automatically on boot, when a known error occurs, or manually while troubleshooting or checking the system. The system can offer a diagnostic scan when the system software encounters something unusual. Initiating a diagnostic scan can include selecting which type diagnostic scan to perform as well as which portion of the available scans to perform. In step 1404 of FIG. 14, a selected network-component is scanned by the diagnostic scanner 105. The diagnostic scanner 105 accesses or includes a memory that contains a table or database. The table/database includes a list of diagnostic tests to perform while scanning (e.g., a series of “line items” for the tests to perform while scanning). Starting with a first line item (or test) on the list, the diagnostic scanner 105 scans the components and collects hardware information and software configuration information. Note that a particular component may have multiple line items for scanning (e.g., hardware configuration, configuration files, and software and/or driver versions). Note that a line-item test may include one or more steps or procedures to be performed in completing the test. That is, a single test may be used to scan or access more than one aspect of a component. Alternatively, multiple tests and line items may be assigned to a single component. In one embodiment an exemplary diagnostic scan includes over 100 line items or tests to perform.

In step 1406 of FIG. 14, the test data for a line item's test (e.g., a hardware configuration, configuration file, or a software/driver version associated with a particular component) is compared to the line item scan data from a previous reference scan of the system 100. By comparing the results of the scan to a reference scan, a change (if any) from the reference scan can be determined. As discussed herein, a change in the test data (with respect to reference data) can be an indication that a critical component is no longer working as expected.

In step 1408 of FIG. 14, the degree of change from the reference state for the current line item is ranked according to severity and oddity (or “weirdness”). As noted herein, for each line item, the database includes a ranking for each anticipated change from the reference scan, such that a numerical score (i.e., 0-3) can be determined based on the detected change from the reference scan (see FIGS. 3, 3B, and 3C). Note that if a detected change is not listed in the database, the ranking will be listed as “−1,” which is interpreted as “unknown.” That is, there is a change from the reference scan but it is an unlisted and unknown change. Possibly this change may later be ranked as an unexpected or unanticipated change and be included in a later version of the database for ranking detected scan changes.

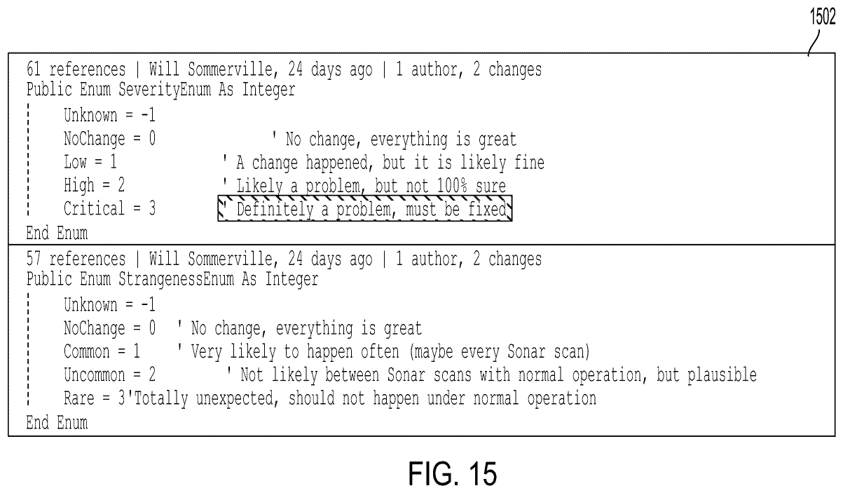

In assessing component changes identified in a diagnostic scan, when a scanned component is determined to have “changed” since a previous scan, the component change is classified in both “severity” and “oddity” (or weirdness) (see FIG. 15). Within the database, associated with each line item is a set of severity rankings and oddity rankings for each of the identified changes with respect to the line item, based on the collective experience of experts in the technology and the industry. For example, there way be three identified changes for a line item that are identified as “minor” or “some” change, but likely to not be an issue. Other identified changes include more significant changes that may or may not be an issue (e.g., a new, additional memory has been installed in a particular component). Lastly, the identified changes may include a serious or critical change that is determined to be an issue (e.g., missing memory in the component that could include important data or programming). These changes may be ranked according to severity from 0-3 as noted below:
−1: unknown change detected.
0: no change from previous scan.
1: low severity change detected from previous scan, but likely not an issue.
2: high/moderate severity change detected that may or may not be an issue, but needs addressed.
3: critical change detected that is certain to be a problem that must be fixed or remedied.

In assessing the component changes there is also a series of “oddity” (or weirdness) rankings for each of the identified changes, based on the collective experience of experts in the technology and the industry. Such oddities or weirdness can be described as to how unexpected or out of the ordinary the scan results are (from the expected). There may be several changes that are identified as common changes that are expected and not an issue (e.g., memory usage of the system is expected to change as the system is running). Other changes may be categorized as uncommon and are unexpected but likely not an issue (but could be). Lastly, there are detected scan changes that are totally unexpected and should not happen during normal operating procedures. Usually, a totally unexpected change warrants close investigation and a higher priority than routine changes. This allows the system to provide useful troubleshooting context even for unforeseen failure modes which the tool could not have predicted. An exemplary ranking of oddity is noted below:
−1: unknown change detected.
0: no change seen in scan compared to previous scan.
1: a common change that is expected.
2: an uncommon change that is unexpected, but not likely an issue, but could be.
3: a rare change that is totally unexpected and should not happen during normal operating procedures/conditions. Likely an issue that needs addressed.

The severity and oddity scores are based upon the determined or perceived needs of the associated system (e.g., a light guide system 100). For example, the controller 102 could include a file or program that determines what content or instructions are displayed on which display 120a, 120b or projected by which projector 118a, 118b. If this file or program is corrupted or missing, the controller 102 is unable to properly display the information and instructions, vital capabilities for an exemplary light guide system. Such a loss or corruption of the monitor configuration file or program could have a high severity and oddity ranking (indicating that the problem is severe and needs to be addressed).

In one embodiment, when desirable, updates and/or overrides are added to the severity and oddity ranking for various changes, so that the customer can teach the system to ignore certain changes or escalate the response of certain changes. The ranked scan results may also cause messages to be sent to remote users over, for example, email, text messages, or various network protocols. This may trigger maintenance personnel to respond or create a service ticket for a vendor to respond to the specific issues found. The ranked scan results may also feed back into an MES 108 system and cause the current station to be bypassed if there are serious configuration issues. Depending on the issues found, the system may limit its own functionality to only allow work that does not depend on the faulty components. For example, the system may forgo automatic vision verification if the camera is not working and ask the operator/user to do manual visual inspection instead.

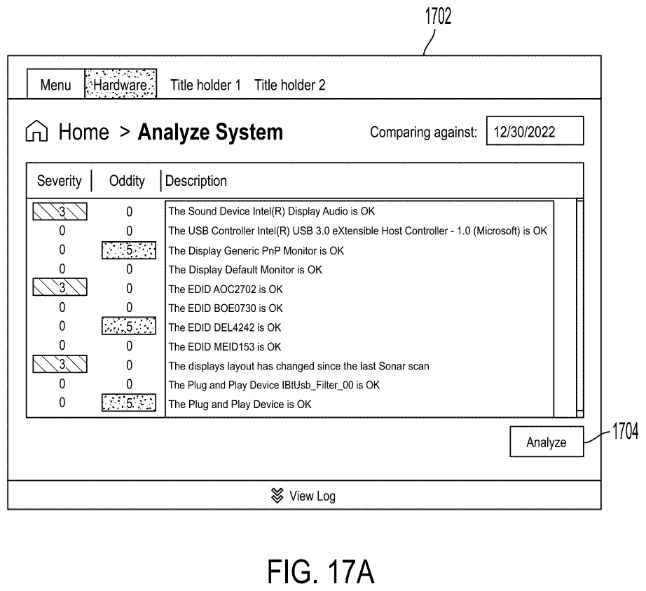

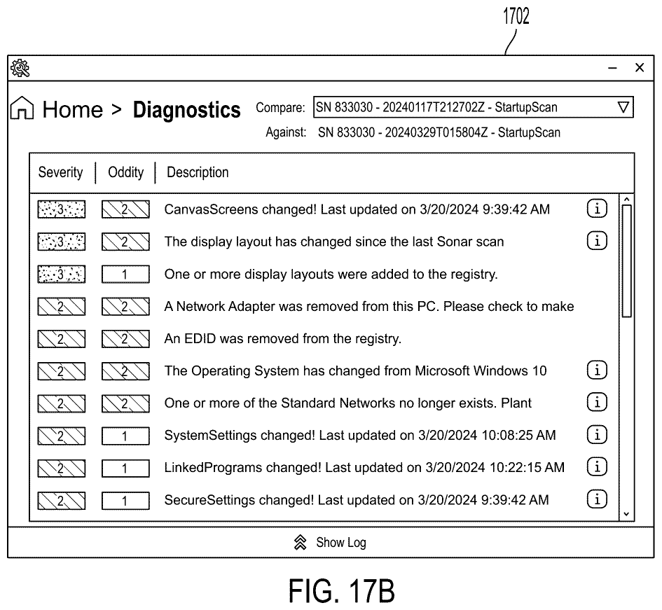

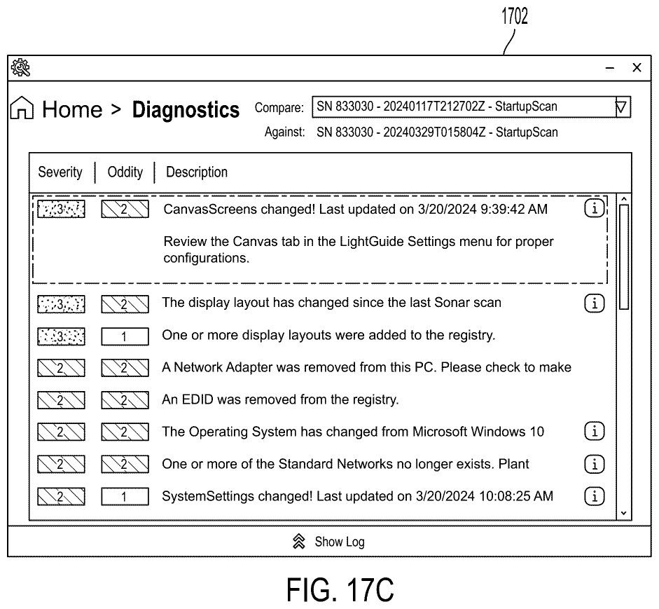

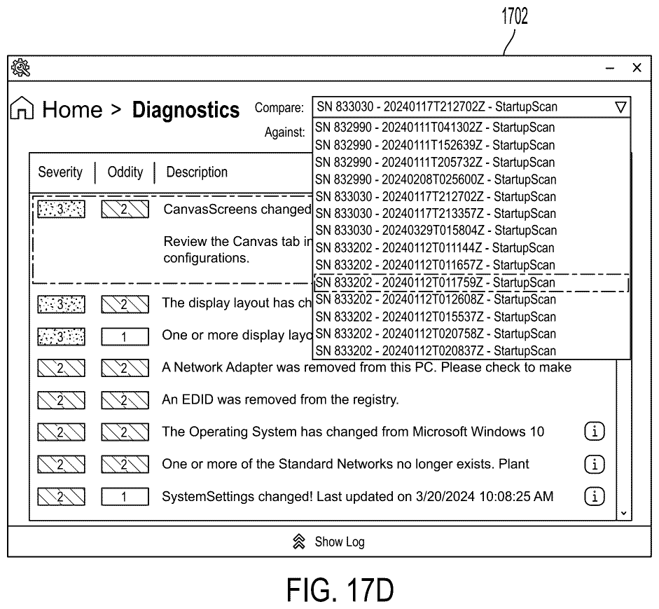

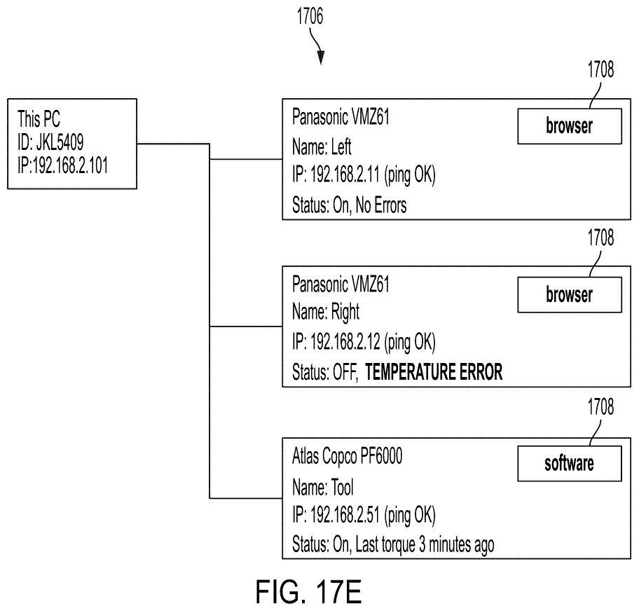

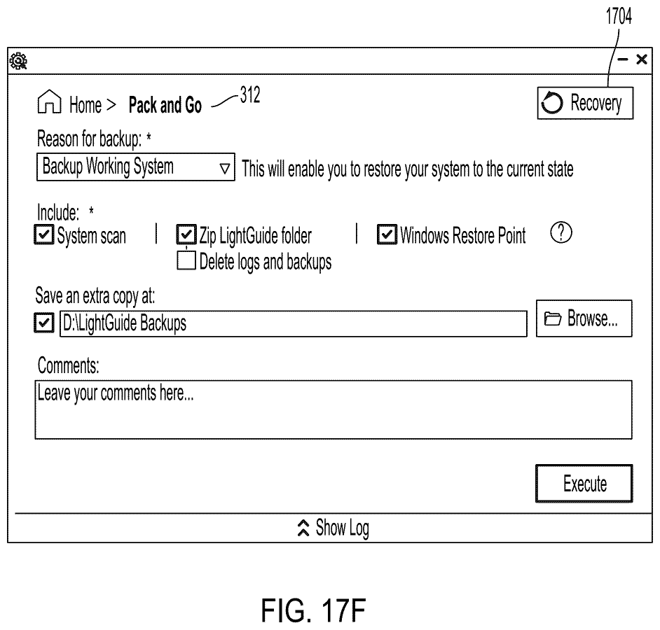

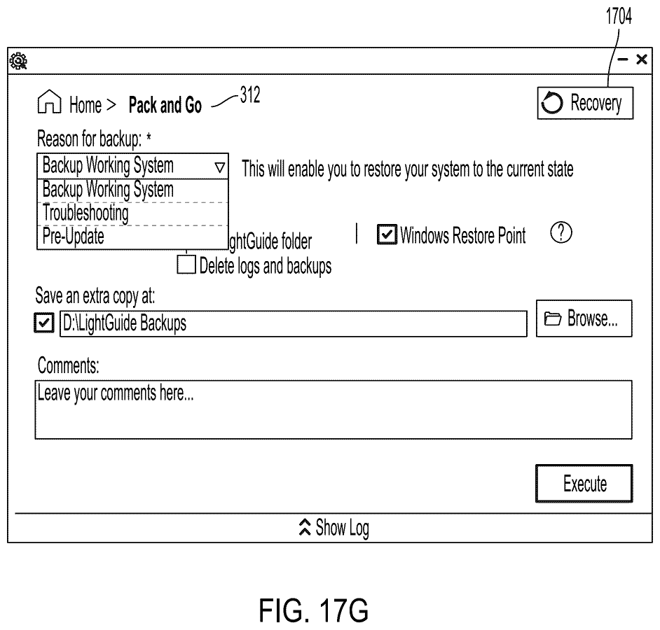

In step 1410 of FIG. 14, the changes (if any) for the current line item's test results are characterized, ranked, and recorded in a diagnostic scan log, such that each line item (and its associated test(s)) in the database will include an entry in the diagnostic scan log. The diagnostic scan log can then be used to create a diagnostic scan report listing the changes and their resulting severity rankings, oddity rankings, and descriptions (see FIG. 17). In step 1412 of FIG. 14, the method determines whether there are any further line items to be scanned. If there are further line items, the method increments to the next line item and returns back to step 1404 of FIG. 14 and the next current line item is scanned. However, if the last line item has been scanned, the method proceeds to step 1414 of FIG. 14 where the diagnostic scan run (i.e., the diagnostic scan log and report) is saved in memory.

In addition to providing a severity ranking and oddity ranking, in one embodiment, a change description is provided to the user. If there was no change from the reference scan, then the description for that particular line item test would be indicated as “OK.” Along with the description of the detected change, a resolution may be displayed to the user that provides a recommendation for resolving the issue(s) associated with the change. In one embodiment, for each detected change a suggested resolution will be offered. Of the suggested resolutions, each suggested resolution will include an indication will be made as to whether the resolution can be completed automatically or if the resolution requires a user to manually perform the resolution. For example, some changes require the user (or test runner) to manually adjust/check configurations and cabling (e.g., when two components are not communicating properly, a suggested resolution may include physically double-checking the network cables communicatively coupling the two components together). After performing any resolution tasks, some part or the entire diagnostic scan could be run again. In another exemplary diagnostic scan, a detected change for a particular monitor may be that the monitor is missing. Depending on the monitor, it is likely that such a change would be ranked with high severity and highly unusual rankings. The associated description could read, for example, “monitor missing,” while the resolution display may include advice for resolving the issue, such as, double-checking cabling, power, and for physical presence of the display. The scan results can be displayed to the user and also provided as a report that can be sent to a remote person. The scan report can also be saved in a local or external memory.

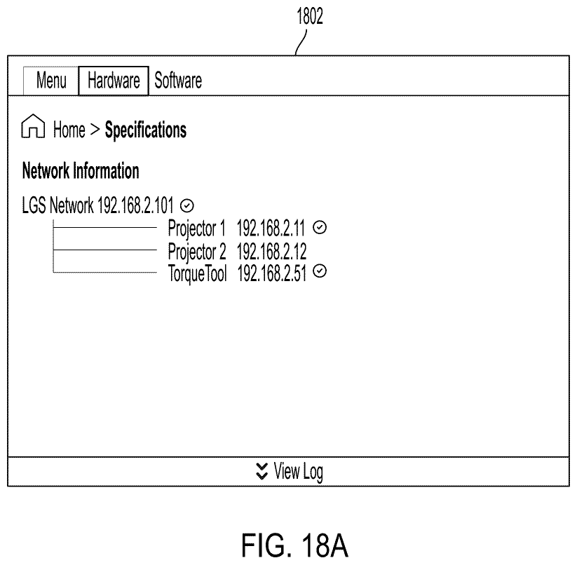

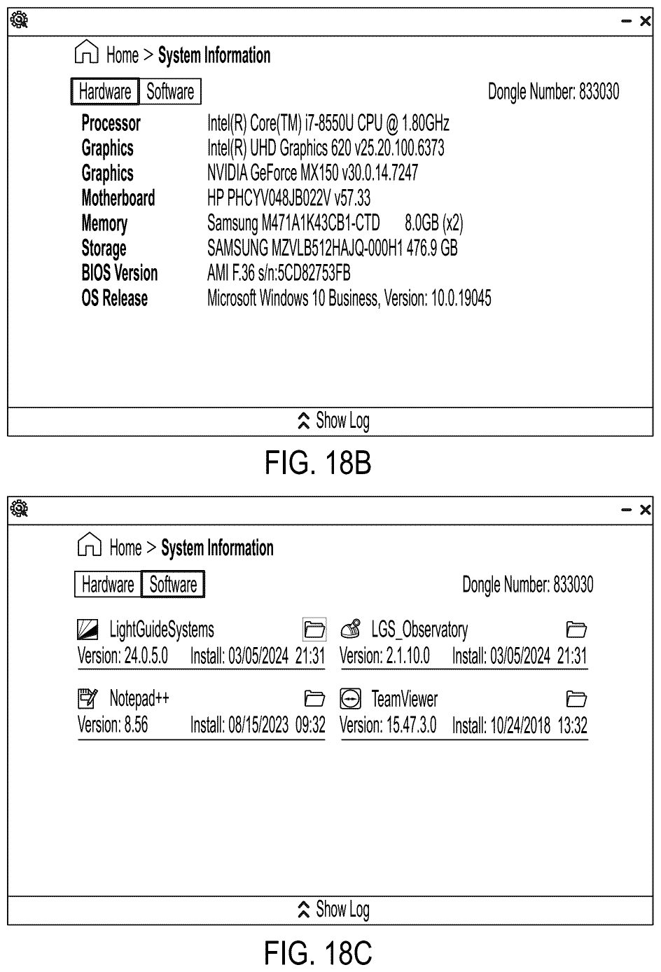

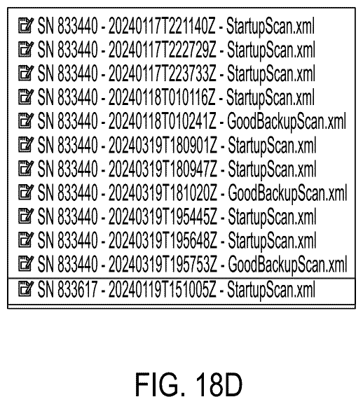

As discussed herein, the results of a diagnostic scan are compared to a reference scan. The reference scan may be a previous scan, such as a previous diagnostic scan that was performed as part of a system repair (e.g., a troubleshooting scan or health check scan). In addition to previous scans, a baseline scan may also be used for comparison. A baseline scan, also considered a “golden scan,” is a system scan that marks a point in the lifecycle of the system 100 where the system 100 is considered fully integrated and operational. As a system is changed, upgraded, or altered, a diagnostic scan performed after the configuration change would be considered a new baseline or golden scan. Note that a current baseline or golden scan is preferred over a previous baseline scan that is no longer considered current or valid. Thus, as part of the diagnostic scan results, an indication will be provided as to what the current diagnostic scan was compared to. As also discussed herein, the diagnostic scan results may provide a network analysis that confirms whether all components of the system are present and working and properly configured (see FIG. 18). Thus, confirmation can be given that the components of the light guide system 100 are present, talking to each other, networked properly, and behaving as expected. Thus, confirmation that all components on the network are present and communicating can be a subtest of the diagnostic scan. Related to issues seen during troubleshooting, subtests of the complete diagnostic scan can be performed to troubleshoot a particular issue with specific components of the system 100. The subtests can also include user instructions that require manual checking (e.g., network and power cable configurations).

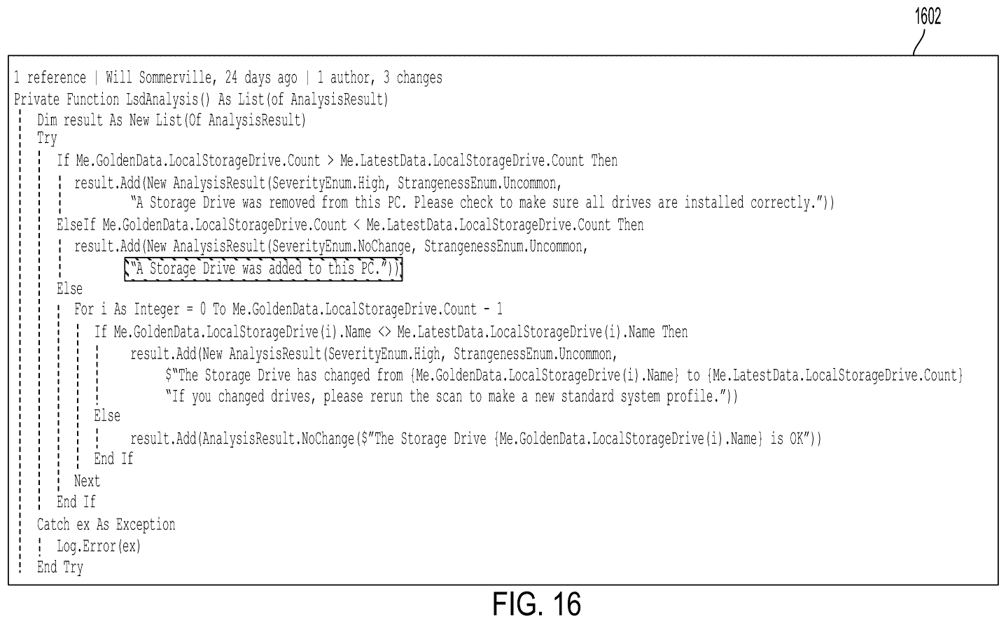

Referring to FIG. 15, a ranking panel 1502 provides a description of the severity rankings and oddity rankings along with their written descriptions. FIG. 16 illustrates an exemplary ranking and assessment panel 1602 that includes a scan of an exemplary line item related to a local storage drive (memory). The ranking and assessment panel 1602 includes exemplary logic for evaluating any changes from a baseline or previous diagnostic scan. For example, if a local storage drive is missing from the scan (indicated when a local storage drive count is lower in the scan as compared to the previous scan), then the severity ranking is high (e.g., severity ranking of 2), the strangeness or oddity ranking is uncommon (e.g., oddity ranking of 2). The resulting exemplary description could include a notification that a storage drive has been removed from the system or a particular component. The resolution instructions would be for the user to make sure that all drives are installed correctly in the component or computer system. In another example, if an extra storage drive has been added to the system (indicated when the local storage drive count is higher in the scan as compared to the previous scan), then the severity ranking is an exemplary “no change” (e.g., severity ranking of 0), while the strangeness or oddity ranking is uncommon (e.g., oddity ranking of 2). The resulting description could be just an indication that a storage device has been added to the component or computer system. The remaining assessment and ranking logic is particular to assessing and ranking “no change” conditions and “unknown” conditions. The resulting description for the no change condition for the scan is an indication that the scan is “OK.” As discussed herein, when the change is unknown or an uncommon change, such as, a different storage drive is now present (replacing a previous drive), the description test could indicate to the user that a storage drive has changed from a previous storage drive serial number (or other identifier) to a new serial number or identifier. A possible resolution or solution offered could be that if the user has changed memory drives that the new scan results for that line item (and possibly all line items for that component) should become part of the new baseline scan. In other words, a new baseline scan should be run based on the hardware changes of the system. In one embodiment, particular scan results may also be ignored going forward if they have been approved. These exceptions might be due to customer policy or because of special cases that should not keep coming up as errors. An exemplary resolution tip/instruction (such as illustrated in FIG. 16) is also illustrated in FIG. 17C, where “clicking” on the “(i)” button provides the additional resolution tip/instruction.

As described herein, the exemplary resolution instructions can be part of the resolution tips to be displayed to a user, such that the user can try to resolve any changes identified by the diagnostic scanner 105. Thus, the resolution tips or instructions will include suggestions or directions for resolving the conflict with a previous diagnostic scan. That is, the setup tool's recording of the configuration data with the contextual “who,” “what,” “where,” “when,” and “how” of the configuration can be used to provide better diagnostic guidance for the diagnostic scanner 105 and its review of the diagnostic data and the generation of resolution tips/instructions. Therefore, the diagnostic scanner 105 has access to what went into the system setup (via the setup tool 101) and can use that setup/configuration information to help guide diagnostics and the generation of relevant and helpful resolution tips/instructions for the user.

Referring to FIGS. 17A, 17B, 17C, and 17D, a system analysis scan report 1702 includes severity rankings and oddity rankings for each line item or component of the system. Note that a description of the results for the particular line item or component are also listed. Note that FIGS. 17B-17D illustrate an alternative display panel from the display panel illustrated in FIG. 17A. Note that the system analysis panel 1702 includes an analysis button 1704 for running a selected diagnostic scan that is compared to a selected previous scan. In one exemplary embodiment, the noted differences between the current system and a previous scan can be sorted such that the more severe or unusual differences are sorted to the top of the list. Such sorting can be used to bring the more severe or unusual differences to the top of the list to help get the user's attention and potentially saving time by focusing the user's attention on the more significant or interesting differences. As illustrated in FIG. 17C, when the user “clicks” the “(i)” button on the right side of the display panel, more information is provided, helping the user to figure out what to do with each line item (e.g., a recommendation for dealing with the issue). As discussed herein, such information is referred to as a resolution tip/instruction. Referring to FIG. 17D, the user is provided with the option of selecting which scans to compare the current scan results against. By default, the diagnostic scanner 105 will compare against a scan associated with a “good backup” of the system when it was known to be working (i.e., a known good state). In one embodiment, the user can look at scans that happen every time the system boots to see when the change first appeared. FIG. 17D illustrates a “startupscan” from the system start up. However, the system could search for “good backup,” “troubleshooting,” and “pre-update” scans too. A scan taken while troubleshooting would often not be compared against, since there was something wrong when that scan was performed.

Referring to FIG. 17E, a hardware status dashboard 1706 can include system details, such as, current hardware topology, state, and other useful information. If applicable, a button 1708 will open a browser window/panel or a software application specific to that hardware component for more diagnostic information. As illustrated in FIG. 17E, an exemplary temperature error on the right projector is indicated. The status dashboard 1706 also provides current state information (e.g., the left projector is on [with no errors], the right projector is off [with a temperature error], and a tool is on [last torque 3 minutes ago]).

Referring to FIGS. 17F and 17G, the “pack and go” feature 312 (accessed from the setup/diagnostics panel 302) provides an opportunity for the user to acquire scans other than startup scans. These backup scans can be used to help get a broken system running again. For example, the user can use the “recovery” button 1704 to restore the system operating system from a backup point. In one embodiment, the recovery button 1704 can open, for example, the Windows Restore feature that is built into the Windows operating system. As illustrated in FIG. 17G, a drop-down list allows the user to select a reason or purpose of a backup (e.g., backup working system, troubleshooting, or pre-update backups). Such would allow the user to mark a good backup versus a troubleshooting backup versus a pre-update backup or scan.

Referring to FIGS. 18A, 18B, 18C, and 18D, an exemplary network analysis report 1802 includes a listing of the components coupled to a particular network (e.g., network 130 of FIG. 1) and an indication of their functionality and communicativeness. As illustrated in FIG. 18A, a particular component of the system (e.g., a projector 118) is listed with a condition (e.g., “OK” checkmark) and a network address (e.g., “192.168.2.11”). Thus, the network analysis report 1802 provides a quick test and report for the user confirming that all components (as applicable) are correctly connected to the network 130 and are functioning properly. FIGS. 18B and 18C provide further information. For example, FIG. 18B depicts a display of system hardware information while FIG. 18C depicts a display of system software information. FIG. 18D illustrates an exemplary folder for organizing and storing scan files. The scan or backup files can be stored according to the purpose of the backup (e.g., using labels “goodbackup,” troubleshooting,” or “startupscan”).

Thus, an exemplary system, such as a light guide system, may include a configuration or setup tool for ensuring a proper setup and configuration of system components. The configuration or setup tool is configured to perform a set of steps to configure a selected component. In one embodiment, the selected component is a monitor and/or a projector. Thus, a system, such as an exemplary light guide system, may include a configuration tool for automatically performing or guiding a user through a configuration process to set up a selected component of the light guide system. When the configuration tool detects errors in the configuration process, a report may be delivered to a diagnostic tool for troubleshooting and error correction. The configuration tool thus provides automated and/or guided configuration procedures for selected components of the light guide system. The exemplary system may also include a diagnostic scanner for comparing a current status of the components of the light guide system to a baseline scan or a selected previous scan. For each difference or chance detected during the scan, the diagnostic scanner will characterize the change and provide a severity ranking and oddity ranking. The diagnostic scanner thus provides a diagnostic scan report that provides a user with an indication of relevant changes in the system as compared to a previous scan that requires some attention or correction. The setup records can also be provided to or utilized by the diagnostic scanner to aid in troubleshooting any diagnostic issues.

Changes and modifications in the specifically described embodiments can be carried out without departing from the principles of the present invention which is intended to be limited only by the scope of the appended claims, as interpreted according to the principles of patent law including the doctrine of equivalents.

1. A configuration and diagnostic apparatus for a system comprises:
a network;
a plurality of components, each communicatively coupled to the network, wherein the plurality of components are configured to perform the system's functionality; and
a configuration tool communicatively coupled to the network and configured to communicate with each of the plurality of components;
a diagnostic tool communicatively coupled to the network and configured to communicate with each of the plurality of components;
wherein the configuration tool is configured to perform a configuration for a selected component of the plurality of components; and
wherein the diagnostic tool is configured to perform a diagnostic scan of each of the components and determine whether resultant scan data has changed from a previous scan's scan data, and wherein the diagnostic tool is configured to evaluate the scan data based at least in part upon related configuration data provided by the configuration tool.

2. The configuration and diagnostic apparatus of claim 1, wherein the configuration tool is configured to access a database for a list of components and related configuration files, wherein each configuration file corresponds to a configuration procedure for a respective component of the plurality of components, wherein the configuration tool is configured to select a configuration file that corresponds to the selected component for configuration, and wherein the database is stored on either a local memory or an external memory, wherein the configuration tool is configured to perform each automated configuration step and provide instructions for the completion of each manual configuration step and to determine whether each of the configuration steps has been completed and verified, and wherein the configuration tool is configured to record corresponding configuration step data, completion data, and verification data for each configuration step.

3. The configuration and diagnostic apparatus of claim 2, wherein each configuration file comprises at least one configuration step for configuring the corresponding component.

4. The configuration and diagnostic apparatus of claim 1, wherein the configuration tool comprises a system setup tool and/or a display setup tool, wherein the system setup tool is configured to perform or guide a user through a system component configuration, and wherein the display setup tool is configured to perform or guide a user through a display configuration.

5. The configuration and diagnostic apparatus of claim 4, wherein the display is one of a monitor, a projector, a tablet, a phone, a wearable device, or some other electronic device.

6. The configuration and diagnostic apparatus of claim 1, wherein the configuration tool is configured to output configuration data to a log, and wherein the diagnostic tool is configured to access the configuration data for use in evaluating the scan data.

7. The configuration and diagnostic apparatus of claim 6, wherein the diagnostic tool is configured to troubleshoot and correct configuration errors in system components, wherein the diagnostic tool is configured to receive the log from the configuration tool, wherein the diagnostic tool is configured to run a list of tests during the diagnostic scan, wherein each test corresponds with a line item in the list of tests, wherein the diagnostic scan comprises at least one line item for each component, and wherein the diagnostic tool accesses the list of tests from a database stored on either a local memory or an external memory.

8. The configuration and diagnostic apparatus of claim 7, wherein the line-item tests comprise tests to determine at least one of: a configuration, a software version and status, an operational state or condition of the component, and information related to software drivers utilized by the component, and wherein the diagnostic tool is configured to identify whether a line item test's scan data has changed.

9. The configuration and diagnostic apparatus of claim 1, wherein the system is a light guide system configured to monitor and guide manufacturing activities.

10. The configuration and diagnostic apparatus of claim 9, wherein the components comprise at least one of: a plurality of cameras, a plurality of projectors, a plurality of monitors, a system controller, one or more external computer systems, input/output devices, and a manufacturing execution system.

11. The configuration and diagnostic apparatus of claim 10, wherein the pluralities of cameras are configured to monitor the activities of workers at workstations in a manufacturing area, and wherein the pluralities of projectors and monitors are configured to display information to the workers and to guide manufacturing activities at the workstations.

12. The configuration and diagnostic apparatus of claim 8, wherein the configuration tool is configured to display a visual timeline of the configurations and errors of the system based on the log, and wherein the configuration tool is configured to highlight serious and/or strange items in the visual timeline, and wherein the diagnostic tool is configured to access the changed scan data for each respective line-item test and rank them according to their severity and oddity with respect to the system's ability to operate as expected.

13. The configuration and diagnostic apparatus of claim 12, wherein rankings according to severity and oddity are updated over time based on performance metrics of the system or experience gained from servicing the system.

14. The configuration and diagnostic apparatus of claim 12, wherein the configuration tool and/or the diagnostic tool comprises machine learning used to highlight components in the system that are showing unusual behavior.

15. The configuration and diagnostic apparatus of claim 6, wherein the configuration tool is configured to output the logs and configuration data to a central server to process and analyze results of the configuration, wherein the central server processes and analyzes results of individual systems for centralized management.

16. The configuration and diagnostic apparatus of claim 1, wherein the configuration tool is configured to prevent the system from running without user acknowledgement of any configurations remaining incomplete, and wherein the diagnostic tool is configured to output scan results to the system, and wherein the system is configured to bypass selected components of the plurality of components and to limit work to perform based on the scan results.

17. The configuration and diagnostic apparatus of claim 12, wherein the diagnostic tool is configured to generate one or more resolution tips to resolve at least one of the identified occurrences of changed scan data for a particular line-item test, wherein the resolution tips are defined at least in part on related configuration data provided by the configuration tool.

18. A configuration apparatus for a system comprises:
a network;
a plurality of components, each communicatively coupled to the network, wherein the plurality of components are configured to perform the system's functionality; and
a configuration tool communicatively coupled to the network and configured to communicate with each of the plurality of components;
wherein the configuration tool is configured to perform a configuration for a selected component of the plurality of components.

19. A diagnostic scanner for a system comprises:
a network;
one or more components, each communicatively coupled to the network, wherein the one or more components are configured to perform the system's functionality; and
a diagnostic tool communicatively coupled to the network and configured to communicate with each of the one or more components;
wherein the diagnostic tool is configured to perform a diagnostic scan of each of the components and determine whether resultant scan data has changed from a previous scan's scan data.
